(19) United States
(12) Patent Application Publication
(10) Pub. No.: US 2017/0196249 A1
(43) Pub. Date: Jul. 13, 2017

(54) NUTRITIONAL POWDER PODS COMPRISING DRY BLENDED CARBOHYDRATES

(71) Applicant: ABBOTT LABORATORIES, Abbott Park, IL (US)

(72) Inventors: CYNTHIA BLACK, Westerville, OH (US); YOUNGSUK HEO, Powell, OH (US); TIMOTHY LAPLANTE, Powell, OH (US); PETER WESTFALL, Westerville, OH (US); GARY KATZ, Columbus, OH (US); SANDRA WEIDA, Delaware, OH (US); CATHERINE LAMB, Westerville, OH (US)

(73) Assignee: ABBOTT LABORATORIES, Abbott Park, IL (US)

(21) Appl. No.: 15/327,934

(22) PCT Filed: Jul. 21, 2015
(86) PCT No.: PCT/US2015/041366

§ 371 Date: Jan. 20, 2017

Related U.S. Application Data
(60) Provisional application No. 62/027,048, filed on Jul. 21, 2014.
(60) Provisional application No. 62/026,885, filed on Jul. 21, 2014.

(51) Int. Cl. A23L 33/10; A23P 30/20; A23P 10/20; A23L 33/00

(52) U.S. Cl. CPC A23L 33/10; A23L 33/40; A23P 30/20; A23P 10/20; A23V 2002/00

(57) ABSTRACT

A nutritional powder pod suitable for use in a beverage production machine and methods of manufacturing and using the same are provided. The nutritional powder pod includes a pod containing a nutritional powder. The nutritional powder includes a carbohydrate and may include a protein, a fat, or both a protein and a fat. At least about 5 wt % of the carbohydrate in the nutritional powder is dry blended into the final nutritional powder.

### CROSS-REFERENCE TO RELATED APPLICATIONS

This application claims priority to and the benefit of U.S. Provisional Patent Application No. 62/027,048, filed Jul. 21, 2014, and U.S. Provisional Patent Application No. 62/026,885, filed Jul. 21, 2014, the entire contents of which are incorporated by reference herein.

### FIELD

The present disclosure generally relates to nutritional powder pods suitable for use in a beverage production machine and methods of manufacturing and using the same. More particularly, the present disclosure relates to a nutritional powder pod comprising a pod containing a nutritional powder that includes dry blended carbohydrates and methods of manufacturing and using the same.

### BACKGROUND

Nutritional powders, such as powdered infant formulas and powdered beverage products, are popular for providing primary, supplemental, or sole nutrition to the end user. These nutritional powders are typically combined with a liquid, such as water, to render the nutritional powder suitable for oral consumption. However, when such nutritional powders are combined with a liquid, the powder tends to clump together and as a result is often not distributed evenly throughout the liquid. To remove or break-up the powder clumps it is often necessary to stir or shake the liquid (sometimes rather vigorously) to break apart the powder clumps so that the powder is distributed throughout the liquid.

### SUMMARY

Disclosed herein are nutritional powder pods suitable for use in a beverage production machine and methods of manufacturing and using the same. To illustrate various aspects of the present disclosure, several exemplary embodiments of nutritional powder pods and methods of manufacturing and using the same are provided herein.

In one exemplary embodiment, a nutritional powder pod for use in a beverage production machine is provided. The nutritional powder pod comprises a pod containing a nutritional powder. The nutritional powder comprises a carbohydrate and at least one of a protein and a fat. At least about 5 wt % of the carbohydrate in the nutritional powder is provided by a carbohydrate that is dry blended into the nutritional powder, hereinafter a “dry blended carbohydrate.”

In one exemplary embodiment, a method of manufacturing a nutritional powder pod suitable for use in a beverage production machine is provided. The method includes providing a base nutritional powder, dry blending a carbohydrate into the base nutritional powder to form a final nutritional powder, and enclosing the final nutritional powder into a pod, thereby forming a nutritional powder pod. At least about 5 wt % of the carbohydrate in the final nutritional powder is provided by the dry blended carbohydrate.

In one exemplary embodiment, a process for preparing a liquid product is provided. The process includes using a nutritional powder pod as described herein with a beverage production machine to mix a liquid with the nutritional powder pod such that the nutritional powder contained therein is reconstituted, thereby producing a liquid product.

In one exemplary embodiment, a nutritional powder pod made according to a specified process is provided. The process includes providing a base nutritional powder, dry blending a carbohydrate into the base nutritional powder to form a final nutritional powder such that at least about 5 wt % of the carbohydrate in the final nutritional powder is provided by the dry blending of the carbohydrate, and enclosing the final nutritional powder into a pod, thereby forming a nutritional powder pod.

### BRIEF DESCRIPTION OF THE DRAWINGS

FIG. 1 illustrates the bottom and top sections of an exemplary bulk density test cylinder.

FIG. 2 illustrates an exemplary modified vibration tester used for the vibrated bulk density test method described herein.

FIG. 3 is a graph illustrating the average rate of reconstitution (powder solids in product vs. reconstitution time) of exemplary dry blended powders.

FIG. 4 is a graph illustrating the average rate of reconstitution (powder solids in product vs. reconstitution time) of spray dried powders.

### DETAILED DESCRIPTION

Disclosed herein are nutritional powder pods suitable for use in a beverage production machine and methods of manufacturing and using the same. While the present disclosure describes certain embodiments of the nutritional powder pod and methods in detail, the present embodiments are considered exemplary and the invention is not intended to be limited to the disclosed embodiments.

### Definitions

The term “adult nutritional product” as used herein, unless otherwise specified, refers to a nutritional composition that is designed for adults to potentially serve as a supplemental, primary, or sole source of nutrition.

The term “bulk density” as used herein, unless otherwise specified, refers to the density of powder or other finely-divided solid without excluding the open space. Bulk density is calculated by dividing the mass of a given portion of a powder by the total powder volume.

The terms “dry blended” and “dry blending” as used herein, unless otherwise specified, are used interchangeably to refer to mixing or blending together one or more dry ingredients, such as a carbohydrate, with a base nutritional powder. In addition, the term “dry blended” may refer to a dry ingredient, such as a carbohydrate, that is mixed or blended together with a base nutritional powder. In this context, a “dry ingredient” may include some amount of water or moisture, such as less than about 10 wt % water by weight of the dry ingredient.

The term “infant” as used herein, unless otherwise specified, refers to a human about 36 months of age or younger. The term “toddler” as used herein, unless otherwise specified, refers to a subgroup of infants from about 12 months of age to about 36 months of age. The terms “child” and “children” as used herein, unless otherwise specified, are used interchangeably to refer to a human about 3 years of age to about 18 years of age. The term “adult” as used herein, unless otherwise specified, refers to a human about 18 years of age or older.

The term “infant formula” as used herein, unless otherwise specified, refers to a nutritional composition designed for infants that contains sufficient nutrients to potentially serve as a supplemental, primary, or sole source of nutrition. Infant formulas preferably comprise nutrients in accordance with the relevant infant formula guidelines for the targeted consumer or user population, an example of which would be the Infant Formula Act, 21 U.S.C. §350(a).

The term “initiation time” as used herein, unless otherwise specified, refers to the time at which any liquid from a beverage production machine first makes contact with or otherwise impinges upon the contents of a pod.

The term “liquid product” as used herein, unless otherwise specified, refers to the reconstituted nutritional powder.

The term “loose bulk density” as used herein, unless otherwise specified, refers to the density (grams per unit volume) of nutritional powder that has not been tapped, packed, compressed, vibrated, or otherwise allowed to settle. It should be understood that for purposes of measuring loose bulk density on a given portion of a nutritional powder, a powder that has been tapped, packed, compressed, vibrated, or otherwise allowed to settle, can be re-distributed according to analytical methods such that loose bulk density can be measured.

The terms “nutritional powder” and “final nutritional powder” as used herein, unless otherwise specified, are used interchangeably herein to refer to a nutritional composition in the form of finely divided solid particles that are flowable or scoopable, and which includes a dry blended carbohydrate that comprises at least about 5 wt % of the total carbohydrates of the composition. A nutritional powder may be reconstituted upon addition of a liquid, such as water, to form a liquid product prior to consumption by a user. As discussed below, in certain embodiments disclosed herein, the nutritional powder comprises a carbohydrate and at least one of a protein and a fat. The nutritional powders described herein are generally suitable for oral consumption (after reconstitution) by a human infant, toddler, child, or adult.

The term “nutritional powder pod” as used herein, unless otherwise specified, refers to a pod containing a certain volume or mass of a nutritional powder.

The term “pediatric formula” as used herein, unless otherwise specified, refers to a nutritional composition designed for children that contains sufficient nutrients to potentially serve as a supplemental, primary, or sole source of nutrition.

The term “pod” as used herein, unless otherwise specified, refers to a sealable, re-sealable, or sealed container having an internal volume capable of containing a solid, powder, or liquid formulation that, when mixed with liquid, yields a liquid product suitable for human consumption.

The terms “reconstitute,” “reconstituted,” and “reconstitution” as used herein, unless otherwise specified, are used interchangeably to refer to a process by which the nutritional powder is mixed with a liquid, such as water, to form an essentially homogeneous liquid product. Once reconstituted with the liquid, the ingredients of the nutritional powder may be any combination of dissolved, dispersed, suspended, colloidally suspended, emulsified, or otherwise blended within the matrix of the liquid product. Therefore, the resulting reconstituted liquid product may be characterized as any combination of a solution, a dispersion, a suspension, a colloidal suspension, an emulsion, or a homogeneous blend.

The term “serving” as used herein, unless otherwise specified, is any amount of a composition that is intended to be ingested by a subject in one sitting or within less than about one hour. The size of a serving (i.e., “serving size”) may be different for diverse individuals, depending on one or more factors including, but not limited to, age, body mass, gender, species, or health. For a typical human child or adult, a serving size of the compositions disclosed herein is from about 25 mL to about 1,000 mL. For a typical human infant or toddler, a serving size of the compositions disclosed herein is from about 5 mL to about 250 mL.

The term “suitable for oral consumption” as used herein, unless otherwise specified, refers to the transformation of a formulation (including, but not limited to, a nutritional composition) from a product form not intended for direct oral consumption to a product form intended for direct oral consumption. For example, reconstituting a reconstitutable powder to form a food product or beverage is considered rendering the reconstitutable powder suitable for oral consumption. As another example, diluting a concentrated liquid to form a food product or beverage is considered rendering the concentrated liquid suitable for oral consumption.

The term “vibrated bulk density” as used herein, unless otherwise specified, refers to the density (grams per unit volume) of powder that has been compressed using the Vibrated Bulk Density Test method, described below.

### Nutritional Powder Pods

The exemplary nutritional powder pods according to the present disclosure comprise a pod containing a nutritional powder. The nutritional powder contained within the pod comprises a carbohydrate and at least one of a protein and a fat. At least about 5 wt % of the carbohydrate in the nutritional powder is provided by a dry blended carbohydrate. In certain embodiments, the nutritional powder pods can be described as suitable for use in a beverage production machine configured to mix a liquid, such as water, with the nutritional powder contained therein to reconstitute it, thereby producing a liquid product. In one exemplary embodiment, a package containing a plurality of nutritional powder pods according to any of the various embodiments described herein is provided. In one exemplary embodiment, a kit comprising a beverage production machine and a nutritional powder pod according to any of the various embodiments described herein for use with the beverage production machine is provided.

As noted above, the pod can be considered a container that encloses the nutritional powder. In certain embodiments, the pod includes one or more chambers therein and the nutritional powder is housed in at least one of the chambers. Generally, the pod may have a wide variety of shapes, sizes, and forms for housing the nutritional powder. For example, in certain exemplary embodiments, the pod may be formed as a cup, a cartridge, or a pouch. Generally, the pod is molded or otherwise constructed of a food-safe material, e.g., a plastic such as polypropylene or polyethylene, a metal or metal foil such as steel or aluminum, a natural product such as paper or other fiber based material, and combinations thereof. In certain embodiments, the pod is sealed, sealable, or re-sealable so as to protect the enclosed nutritional powder from external contamination and/or to retard degradation of the enclosed nutritional powder prior to use. In certain embodiments, the nutritional powder may be contained in the pod such that a headspace in the pod includes a maximum of about 10% O₂ (i.e., less than or equal to about 10% O₂), thereby reducing oxidation of the nutritional powder and preventing the development of undesirable flavors, smells, and textures.

In general, the pod is configured for use with (e.g., intended for use with, suitable for use with) a beverage production machine, such as a single-serving beverage machine. In certain embodiments, the pod is used (i.e., a liquid product can be produced therefrom) by inserting the pod into, or otherwise interfacing the pod with, a beverage production machine. Generally, the beverage production machine is configured to mix a liquid, such as water, with the nutritional powder contained in the pod to reconstitute it, thereby producing a liquid product suitable for consumption by individuals.

In certain embodiments, the pod may be configured to receive an injector or similar device through which water, air, or other fluids (e.g., steam) may be introduced to facilitate mixing and reconstitution within the enclosed volume. In certain embodiments, the fluid introduced to the pod may be pre-filtered, or alternatively the fluid may pass through a filtration unit disposed within the pod. In certain embodiments, an outlet member integrally formed as part of or movably coupled to the pod may be positioned for dispensing from the pod.

In general, all of the nutritional powder contained within the pod is intended to be used to produce a liquid product by utilizing a beverage production machine. In certain embodiments, the pod is a single-use, disposable container. In certain embodiments, the contents of the pod (i.e., the nutritional powder) is intended to be processed (i.e., reconstituted into a liquid product suitable for oral consumption by an individual) within seconds after a seal of the pod is broken or disrupted to allow liquid to flow therein, the contents to flow therefrom, or a combination thereof. In such embodiments, the pod will typically be a single-use, disposable container. In other embodiments, the pod is sealable or re-sealable and is capable of re-use. In certain embodiments where the pod is sealable or re-sealable, the contents of the pod (i.e., the nutritional powder) may be stored for a short time (typically hours or days) by the consumer prior to reconstituting into a liquid product, and the pod may or may not be hermetically sealed at any point.

In certain embodiments, any delay between the time a hermetic seal of the pod is disrupted and an initiation time is less than 1 second. In other embodiments, any delay between the time the hermetic seal of the pod is disrupted and the initiation time is less than 2 seconds. In other embodiments, any delay between the time the hermetic seal of the pod is disrupted and the initiation time is less than 3 seconds. In other embodiments, any delay between the time the hermetic seal of the pod is disrupted and the initiation time is less than 4 seconds. In other embodiments, any delay between the time the hermetic seal of the pod is disrupted and the initiation time is less than 5 seconds. In other embodiments, any delay between the time the hermetic seal of the pod is disrupted and the initiation time is within the range of 1 second to 10 seconds. In some embodiments, a delay between the time the hermetic seal of the pod is disrupted and the initiation time is within the range of 1 second to 30 seconds.

In certain embodiments, the pod may be configured to contain an amount of nutritional powder corresponding to a single serving. In certain such embodiments, the amount of the nutritional powder corresponding to a single serving may vary, for example, based on the intended consumer (e.g., an infant, a toddler, a child, an adult). In certain embodiments, the nutritional powder pod may include an amount of nutritional powder corresponding to multiple servings.

In certain embodiments, the nutritional powder pod contains an amount of a nutritional powder that is suitable for being reconstituted into a single serving of a liquid product upon combination with a certain volume of liquid, such as water. In certain embodiments, the pod contains about 2 grams to about 150 grams of nutritional powder, including about 2 grams to about 100 grams, including about 2 grams to about 80 grams, including about 2 grams to about 60 grams, including about 2 grams to about 50 grams, including about 2 grams to about 35 grams, including about 2 grams to about 30 grams, including about 2 grams to about 25 grams, including about 2 grams to about 20 grams, including about 2 grams to about 15 grams, including about 2 grams to about 10 grams, including about 5 grams to about 150 grams, including about 5 grams to about 100 grams, including about 5 grams to about 80 grams, including about 5 grams to about 60 grams, including about 5 grams to about 50 grams, including about 5 grams to about 35 grams, including about 5 grams to about 30 grams, including about 5 grams to about 25 grams, including about 5 grams to about 20 grams, including about 5 grams to about 15 grams, including about 10 grams to about 150 grams, including about 10 grams to about 100 grams, including about 10 grams to about 80 grams, including about 10 grams to about 60 grams, including about 10 grams to about 50 grams, including about 10 grams to about 40 grams, including about 10 grams to about 35 grams, including about 10 grams to about 30 grams, including about 10 grams to about 25 grams, including about 10 grams to about 20 grams, including about 20 grams to about 150 grams, including about 15 grams to about 150 grams, including about 15 grams to about 100 grams, including about 15 grams to about 80 grams, including about 15 grams to about 60 grams, including about 15 grams to about 50 grams, including about 15 grams to about 40 grams, including about 15 grams to about 35 grams, including about 15 grams to about 30 grams, including about 15 grams to about 25 grams, including about 20 grams to about 150 grams, including about 20 grams to about 100 grams, including about 20 grams to about 80 grams, including about 20 grams to about 60 grams, including about 20 grams to about 50 grams, including about 20 grams to about 40 grams, including about 20 grams to about 35 grams, including about 20 grams to about 30 grams, including about 25 grams to about 150 grams, including about 25 grams to about 100 grams, including about 25 grams to about 80 grams, including about 25 grams to about 60 grams, including about 25 grams to about 50 grams, including about 25 grams to about 40 grams, including about 25 grams to about 35 grams, including about 30 grams to about 150 grams, including about 30 grams to about 100 grams, including about 30 grams to about 80 grams, including about 30 grams to about 60 grams, including about 30 grams to about 50 grams, including about 30 grams to about 40 grams, including about 40 grams to about 150 grams, including about 40 grams to about 100 grams, including about 40 grams to about 80 grams, including about 40 grams to about 60 grams, including about 40 grams to about 50 grams, including about 50 grams to about 150 grams, and including about 50 grams to about 100 grams of nutritional powder. In certain embodiments, the pods contain about 8 grams, about 10 grams, about 12 grams, about 15 grams, about 20 grams, about 25 grams, about 30 grams, about 35 grams, about 40 grams, about 50 grams, about 60 grams, about 80 grams, about 90 grams, about 100 grams, about 125 grams, or about 150 grams of nutritional powder.

### Nutritional Powders

As discussed above, the nutritional powder pods of the present disclosure comprise a pod containing a nutritional powder. In certain embodiments, the nutritional powder contained within the pod is in the form of a flowable or substantially flowable powder. In certain embodiments, the nutritional powder is in the form of a powder that can be easily scooped and measured with a spoon or similar other device, such that the nutritional powder can accurately be measured for reconstitution with a suitable liquid, typically water, to form a liquid product for immediate consumption. In this context, “immediate” consumption generally means within about 48 hours, more typically within about 24 hours, in some embodiments within about 1 hour, and in some embodiments, immediately after reconstitution.

The nutritional powders contained in the exemplary nutritional powder pods disclosed herein comprise a carbohydrate and at least one of a protein and a fat. For example, in certain exemplary embodiments, the nutritional powder comprises a carbohydrate and a protein. In certain exemplary embodiments, the nutritional powder comprises a carbohydrate and a fat. In certain other exemplary embodiments, the nutritional powder comprises, a carbohydrate, a protein, and a fat. In addition, the nutritional powder, in certain exemplary embodiments, may further comprise vitamins, minerals, and a variety of other ingredients as described herein.

In certain embodiments, the nutritional powder contained in the pod is one of the following: an infant formula, a pediatric formula, an adult nutritional product, a preterm infant formula, an elemental formula, a semi-elemental formula, or a nutritional supplement. In certain embodiments, when the nutritional powder is an infant formula, the nutritional powder pod, the packaging for the nutritional powder pods, or both are labeled with information indicating that the formula within is an infant formula and is intended for consumption by infants. In certain embodiments, when the nutritional powder is a pediatric formula, the nutritional powder pod, the packaging for the nutritional powder pods, or both are labeled with information indicating that the nutritional powder within is a pediatric formula and is intended for consumption by children. In certain embodiments, when the nutritional powder is an adult nutritional product, the nutritional powder pod, the packaging for the nutritional powder pods, or both are labeled with information indicating that the nutritional powder within is an adult nutritional product and is intended for consumption by adults. In certain embodiments, when the nutritional powder is an adult nutritional product, the nutritional powder includes one or more flavorings, examples of which include, but are not limited to vanilla, chocolate, fruit flavors, vegetable flavors, coffee, and butter pecan.

In certain embodiments, the nutritional powder may be formulated with sufficient kinds and amounts of nutrients so as to provide a sole, primary, or supplemental source of nutrition for the individual for whom the nutritional powder is intended (i.e., an infant, a child or an adult).

Generally, the nutritional powders of the present disclosure will have a caloric density tailored to the nutritional needs of the intended user, or will provide such caloric density upon reconstitution with a liquid, such as water. For example, when the nutritional powder is an infant formula, the caloric density will generally be at least about 19 kcal/fl oz (about 640 kcal/liter), more typically from about 20 kcal/fl oz (676 kcal/liter) to about 25 kcal/fl oz (about 845 kcal/liter), even more typically from about 20 kcal/fl oz (about 676 kcal/liter) to about 24 kcal/fl oz (about 810 kcal/liter). Infant formulas having a caloric density of from about 22 kcal/fl oz (about 745 kcal/liter) to about 24 kcal/fl oz (about 810 kcal/liter) are more commonly used for pre-term or low birth weight infants, and infant formulas having a caloric density of from about 20 kcal/fl oz (about 676 kcal/liter) to about 21 kcal/fl oz (about 710 kcal/liter) are more often used for term infants. When the nutritional powder is a pediatric formula or an adult nutritional product, the nutritional powder may have any caloric density suitable for a child or an adult.

### Dry Blended Carbohydrates

As discussed above, in the exemplary embodiments disclosed herein, at least about 5 wt % of the total carbohydrates in the nutritional powder is provided by a dry blended carbohydrate. Without being bound by theory, it is believed that by using at least about 5 wt % of dry blended carbohydrate, the nutritional powder contained within the pod will exhibit optimal reconstitution characteristics (e.g., reconstitution yield, rate of reconstitution) when the nutritional powder pod is used in a beverage production machine. Without wishing to be limited to any particular theory, it is believed that dry blending carbohydrates into the nutritional powder intersperses the particles of the dry blended carbohydrates amongst the particles of the nutritional powder, which increases the overall wetting surface area of the powder particles reducing the tendency of the powder particles from clumping upon reconstitution with a liquid.

The reconstitution characteristics of the nutritional powder can be varied depending on the amount of dry blended carbohydrates incorporated into the nutritional powder. In certain embodiments, from about 10 wt % to about 100 wt % of the total carbohydrates in the nutritional powder is provided by a dry blended carbohydrate. In certain embodiments, from about 20 wt % to about 80 wt % of the total carbohydrates in the nutritional powder is provided by a dry blended carbohydrate. In certain embodiments, from about 40 wt % to about 60 wt % of the total carbohydrates in the nutritional powder is provided by a dry blended carbohydrate. In certain embodiments, from about 5 wt % to about 20 wt % of the total carbohydrates in the nutritional powder is provided by a dry blended carbohydrate. In certain embodiments, from about 80 wt % to about 100 wt % of the total carbohydrates in the nutritional powder is provided by a dry blended carbohydrate. In certain embodiments, 100 wt % of the carbohydrates in the nutritional powder is provided by a dry blended carbohydrate.

Carbohydrates suitable for dry blending into the nutritional powder disclosed herein can be simple, complex, or combinations thereof, and are generally in powdered form. Non-limiting examples of carbohydrates suitable for dry blending into the nutritional powder include lactose, sucrose, fructose, glucose, inulin, fructooligosaccharides (FOS), galactooligosaccharides (GOS), maltodextrin, corn syrup solids, starch, polydextrose, sugar alcohols (e.g., erythritol, maltitol, glycerol, xylitol, isomalt), and combinations thereof. When an ingredient is added to the nutritional powder in dry blended form, it may be referred to herein as dry blended “ingredient X” (e.g., dry blended “lactose”). In certain embodiments, the dry blended carbohydrate in the nutritional powder comprises lactose, and thus, the nutritional powder contains dry blended lactose. In certain embodiments, the dry blended carbohydrate in the nutritional powder comprises sucrose, and thus, the nutritional powder contains dry blended sucrose. In certain embodiments, the dry blended carbohydrate in the nutritional powder comprises FOS, and thus, the nutritional powder contains dry blended FOS. In certain embodiments, the dry blended carbohydrate in the nutritional powder comprises starch, and thus, the nutritional powder contains dry blended starch. In certain embodiments, the dry blended carbohydrate in the nutritional powder comprises corn syrup solids, and thus, the nutritional powder contains dry blended corn syrup solids.

In certain embodiments, the dry blended carbohydrate in the nutritional powder comprises lactose and sucrose, and thus, the nutritional powder contains dry blended lactose and dry blended sucrose. In certain such embodiments, the dry blended lactose and dry blended sucrose are present in relative weight amounts ranging from about 10:90 to about 90:10, including from about 20:80 to about 80:20, from about 30:70 to about 70:30, from about 40:60 to about 60:40, and also including about 50:50.

In certain embodiments, the dry blended carbohydrate in the nutritional powder comprises sucrose and maltodextrin, and thus, the nutritional powder contains dry blended sucrose and dry blended maltodextrin. In certain such embodiments, the dry blended sucrose and dry blended maltodextrin are present in relative weight amounts ranging from about 10:90 to about 90:10, including from about 20:80 to about 80:20, from about 30:70 to about 70:30, from about 40:60 to about 60:40, and also including about 50:50.

In certain embodiments, the dry blended carbohydrate in the nutritional powder comprises lactose and maltodextrin, and thus, the nutritional powder contains dry blended lactose and dry blended maltodextrin. In certain such embodiments, the dry blended lactose and dry blended maltodextrin are present in relative weight amounts ranging from about 10:90 to about 90:10, including from about 20:80 to about 80:20, from about 30:70 to about 70:30, from about 40:60 to about 60:40, and also including about 50:50.

In certain embodiments, the dry blended carbohydrate in the nutritional powder comprises fructose and maltitol, and thus, the nutritional powder contains dry blended fructose and dry blended maltitol. In certain such embodiments, the dry blended fructose and dry blended maltitol are present in relative weight amounts ranging from about 10:90 to about 90:10, including from about 20:80 to about 80:20, from about 30:70 to about 70:30, from about 40:60 to about 60:40, and also including about 50:50.

A variety of analytical methods may be used to characterize certain physical properties of the nutritional powder, including the type and amount of dry blended carbohydrates present in the nutritional powder. In one example, a method for determining the type and amount of dry blended carbohydrates includes at least one of the following analyses, which optionally may be performed together to obtain a relatively more complete set of information. In a first analysis, a microscope slide is prepared with a sample of the nutritional powder and the slide is placed under a standard stereoscopic microscope to determine the different types of particles present in the nutritional powder in terms of shape, size, color, and transparency, and measurements are recorded. Generally, when the nutritional powder includes a dry blended ingredient, the particles of the dry blended ingredient will differ in at least one of color, size, and shape from the particles of the base nutritional powder. Next, each different type of powder particle that has been identified using the microscope is removed and is tested using infrared vibrational spectroscopy to confirm the chemical identity (e.g., a carbohydrate or other compound) of the powder particle. In a second analysis, a static image analysis sensor, such as the Morphologi G3 available from Malvern Instruments (Malvern, United Kingdom), is used to perform a static image analysis on a sample of the nutritional powder and provide quantitative characterization of the different powder particle shapes and sizes, which can be correlated to the identity of the particle (e.g., dry blended, spray dried). Generally, spray dried particles will appear more spherical than dry blended particles or extruded particles. However, when a spray dried ingredient (e.g., maltodextrin) is dry blended into a base nutritional powder, the particles of the dry blended ingredient (e.g., spray dried maltodextrin) can typically be distinguished from the particles of the base nutritional powder based on color and size. In a third analysis, a sample of the nutritional powder is tested using a differential scanning calorimeter (DSC), such as the Q200 DSC available from TA Instruments (New Castle, Del.). The DSC provides a heat flow thermogram, which can be used to measure and quantify various transitions and transition temperatures (e.g., glass transition). Generally, spray dried particles will have a single glass transition peak whereas a spray dried base powder with dry blended ingredients will have two or more glass transition and/or melting peaks. The quantitative measurements from the static image analysis and the DSC can be correlated to the different types of powder particles identified microscopically to calculate the type and amount of dry blended carbohydrates in the nutritional powder.

In another example, X-ray diffraction may be used to determine the percent crystallinity of the nutritional powder. Percent crystallinity may be used to identify the presence of certain dry blended carbohydrates, such as sucrose, lactose, and other carbohydrates having a crystalline structure, in the nutritional powder.

In certain embodiments, the dry blended carbohydrate can be recognized in the nutritional powder by physical properties. More specifically, in certain embodiments, the dry blended carbohydrate can be recognized by one or more of microscopy and vibrational spectroscopy, static image analysis, DSC, or X-ray diffraction.

### Macronutrients

As discussed above, according to the various embodiments described herein, the nutritional powder comprises a dry blended carbohydrate that comprises at least about 5 weight % of the total carbohydrates present in the nutritional powder and at least one of a protein and a fat. In certain embodiments, the nutritional powder comprises a carbohydrate and a protein. In certain embodiments, the nutritional powder comprises a carbohydrate and a fat. In certain embodiments, the nutritional powder comprises, a carbohydrate, a protein, and a fat. Generally, any source of carbohydrate, protein, or fat that is suitable for use in nutritional products is also suitable for use in the various embodiments of the nutritional powder described herein, provided that such macronutrients are also compatible with the essential elements of the nutritional powders as described herein.

Although total concentrations or amounts of carbohydrates, protein, and fat may vary depending upon the nutritional needs of the particular individual for whom the nutritional powder is formulated, such concentrations or amounts most typically fall within one of the following embodied ranges, inclusive of any other essential protein, carbohydrate, or fat ingredients as described herein.

In certain embodiments, when the nutritional powder is formulated as an infant formula, the protein component is typically present in an amount of from about 5% to about 35% by weight of the infant formula (i.e., the powder infant formula), including from about 10% to about 30%, from about 10% to about 25%, from about 15% to about 25%, from about 20% to about 30%, from about 15% to about 20%, and also including from about 10% to about 16% by weight of the infant formula (i.e., the powder infant formula). The carbohydrate component is typically present in an amount of from about 40% to about 75% by weight of the infant formula (i.e., the powder infant formula), including from about 45% to about 75%, from about 45% to about 70%, from about 50% to about 70%, from about 50% to about 65%, from about 50% to about 60%, from about 60% to about 75%, from about 55% to about 65%, and also including from about 65% to about 70% by weight of the infant formula (i.e., the powder infant formula). The fat component is typically present in an amount of from about 10% to about 40% by weight of the infant formula, including from about 15% to about 40%, from about 20% to about 35%, from about 20% to about 30%, from about 25% to about 35%, and also including from about 25% to about 30% by weight of the infant formula (i.e., the powder infant formula).

In certain embodiments, when the nutritional powder is formulated as a pediatric formula, the protein component is typically present in an amount of from about 5% to about 30% by weight of the pediatric formula (i.e., the powder pediatric formula), including from about 10% to about 25%, from about 10% to about 20%, from about 10% to about 15%, from about 15% to about 20%, and also including from about 12% to about 20% by weight of the pediatric formula (i.e., the powder pediatric formula). The carbohydrate component is typically present in an amount of from about 40% to about 75% by weight of the pediatric formula (i.e., the powder pediatric formula), including from about 45% to about 75%, including from about 45% to about 70%, from about 50% to about 70%, from about 55% to about 70%, and also including from about 55% to about 65% by weight of the pediatric formula (i.e., the powder pediatric formula). The fat component is typically present in an amount of from about 10% to about 25% by weight of the pediatric formula (i.e., the powder pediatric formula), including from about 12% to about 20%, and also including from about 15% to about 20% by weight of the pediatric formula (i.e., the powder pediatric formula).

Additional suitable ranges for proteins, carbohydrates, and fats in those embodiments where the nutritional powder is formulated as an infant formula or a pediatric formula, based on the percentage of total calories of the nutritional powder, are set forth in Table 1.

TABLE 1

| | Embodiment A | Embodiment B | Embodiment C |
|---|---|---|---|
| Macronutrient | (% Calories) | (% Calories) | (% Calories) |
| Protein | 2-75 | 5-50 | 7-40 |
| Carbohydrate | 1-85 | 30-75 | 35-65 |
| Fat | 5-70 | 20-60 | 25-50 |

Note:
Each numerical value in the table is preceded by the term “about.”

In certain embodiments, when the nutritional powder is formulated as an adult nutritional product, the protein component is typically present in an amount of from about 5% to about 35% by weight of the adult nutritional product, including from about 10% to about 30%, from about 10% to about 20%, from about 15% to about 20%, and including from about 20% to about 30% by weight of the adult nutritional product. The carbohydrate component is typically present in an amount of from about 40% to about 80% by weight of the adult nutritional product, including from about 50% to about 75%, from about 50% to about 65%, from about 55% to about 70%, and also including from 60% to 75% by weight of the adult nutritional product. The fat component is typically present in an amount of from about 0.5% to about 20%, including from about 1% to about 15%, from about 1% to about 10%, from about 1% to about 5%, from about 5% to about 20%, from about 10% to about 20%, and also including from about 15% to about 20% by weight of the adult nutritional product.

Additional suitable ranges for proteins, carbohydrates, and fats in those embodiments where the nutritional powder is formulated as an adult nutritional product, based on the percentage of total calories of the nutritional powder, are set forth in Table 2.

TABLE 2

| | Embodiment D | Embodiment E | Embodiment F |
|---|---|---|---|
| Macronutrient | (% Calories) | (% Calories) | (% Calories) |
| Protein | 1-98 | 5-80 | 15-55 |
| Carbohydrate | 1-98 | 0-75 | 20-50 |
| Fat | 1-98 | 20-70 | 25-40 |

Note:
Each numerical value in the table is preceded by the term “about.”

As previously discussed, the nutritional powders disclosed herein include a dry blended carbohydrate that comprises at least about 5 wt % of the total carbohydrates in the nutritional powder. In certain embodiments, all of the carbohydrates in the nutritional powder are provided by a dry blended carbohydrate. Any of the carbohydrates previously discussed as suitable for dry blending into the nutritional powder may be utilized.

In addition to a dry blended carbohydrate, the nutritional powders, in certain embodiments, may include additional carbohydrates that are not dry blended. The carbohydrate or source of carbohydrate suitable for use in the nutritional powders disclosed herein may be simple, complex, or variations or combinations thereof. Generally, the carbohydrate may include any carbohydrate or carbohydrate source that is suitable for use in oral nutritional compositions and is otherwise compatible with any other selected ingredients or features in the nutritional powder.

Non-limiting examples of carbohydrates suitable for use in the nutritional powders described herein include, but are not limited to, polydextrose, maltodextrin; hydrolyzed or modified starch or cornstarch; glucose polymers; corn syrup; corn syrup solids; rice-derived carbohydrate; sucrose; glucose; fructose; lactose; high fructose corn syrup; honey; sugar alcohols (e.g., maltitol, erythritol, sorbitol); isomaltulose; sucromalt; pullulan; potato starch; and other slowly-digested carbohydrates; dietary fibers including, but not limited to, fructooligosaccharides (FOS), galactooligosaccharides (GOS), oat fiber, soy fiber, gum arabic, sodium carboxymethylcellulose, methylcellulose, guar gum, gellan gum, locust bean gum, konjac flour, hydroxypropyl methylcellulose, tragacanth gum, karaya gum, gum acacia, chitosan, arabinogalactans, glucomannan, xanthan gum, alginate, pectin, low methoxy pectin, high methoxy pectin, cereal beta-glucans (e.g., oat beta-glucan, barley beta-glucan), carrageenan and psyllium, digestion resistant maltodextrin (e.g., Fibersol™, a digestion-resistant maltodextrin, comprising soluble dietary fiber); soluble and insoluble fibers derived from fruits or vegetables; other resistant starches; and combinations thereof. The nutritional powders described herein may include any individual source of carbohydrate or combination of the various sources of carbohydrate listed above.

In certain embodiments, the nutritional powder includes protein or a source of protein. Generally, any source of protein may be used so long as it is suitable for oral nutritional compositions and is otherwise compatible with any other selected ingredients or features in the nutritional composition. Non-limiting examples of suitable proteins (and sources thereof) suitable for use in the nutritional powders described herein include, but are not limited to, intact, hydrolyzed, or partially hydrolyzed protein, which may be derived from any known or otherwise suitable source such as milk (e.g., casein, whey), animal (e.g., meat, fish), cereal (e.g., rice, corn, wheat), vegetable (e.g., soy, pea, potato, bean), and combinations thereof. The protein may also include a mixture of amino acids (often described as free amino acids) known for use in nutritional products or a combination of such amino acids with the intact, hydrolyzed, or partially hydrolyzed proteins described herein. The amino acids may be naturally occurring or synthetic amino acids.

More particular examples of suitable protein (or sources thereof) used in the nutritional powders disclosed herein include, but are not limited to, whole cow's milk, partially or completely defatted milk, milk protein concentrates, milk protein isolates, nonfat dry milk, condensed skim milk, whey protein concentrates, whey protein isolates, acid caseins, sodium caseinates, calcium caseinates, potassium caseinates, legume protein, soy protein concentrates, soy protein isolates, pea protein concentrates, pea protein isolates, collagen proteins, potato proteins, rice proteins, wheat proteins, canola proteins, quinoa, insect proteins, earthworm proteins, fungal (e.g., mushroom) proteins, hydrolyzed yeast, gelatin, bovine colostrum, human colostrum, glycomacropeptides, mycoproteins, proteins expressed by microorganisms (e.g., bacteria and algae), and combinations thereof. The nutritional powders described herein may include any individual source of protein or combination of the various sources of protein listed above.

In addition, the proteins for use herein can also include, or be entirely or partially replaced by, free amino acids known for use in nutritional products, non-limiting examples of which include L-tryptophan, L-glutamine, L-tyrosine, L-methionine, L-cysteine, taurine, L-arginine, L-carnitine, and combinations thereof.

In certain embodiments, the nutritional powders described herein include a protein component that consists of only intact or partially hydrolyzed protein; that is, the protein component is substantially free of any protein that has a degree of hydrolysis of 25% or more. In this context, the term “partially hydrolyzed protein” refers to proteins having a degree of hydrolysis of less than 25%, including less than 20%, including less than 15%, including less than 10%, and including proteins having a degree of hydrolysis of less than 5%. The degree of hydrolysis is the extent to which peptide bonds are broken by a hydrolysis chemical reaction. To quantify the partially hydrolyzed protein component of these embodiments, the degree of protein hydrolysis is determined by quantifying the amino nitrogen to total nitrogen ratio (AN/TN) of the protein component of the selected nutritional powder. The amino nitrogen component is quantified by USP titration methods for determining amino nitrogen content, while the total nitrogen component is determined by the Tecator® Kjeldahl method. These analytical methods are well known.

In certain embodiments, the nutritional powder includes a fat or a source of fat. The fat or source of fat suitable for use in the nutritional powders described herein may be derived from various sources including, but not limited to, plants, animals, and combinations thereof. Generally, the fat may include any fat or fat source that is suitable for use in oral nutritional compositions and is otherwise compatible with any other selected ingredients or features in the nutritional powder. Non-limiting examples of suitable fat (or sources thereof) for use in the nutritional powders disclosed herein include coconut oil, fractionated coconut oil, soy oil, high oleic soy oil, corn oil, olive oil, safflower oil, high oleic safflower oil, medium chain triglyceride oil (MCT oil), high gamma linolenic (GLA) safflower oil, sunflower oil, high oleic sunflower oil, palm oil, palm kernel oil, palm olein, canola oil, high oleic canola oil, marine oils, fish oils, algal oils, borage oil, cottonseed oil, fungal oils, eicosapentaenoic acid (EPA), docosahexaenoic acid (DHA), arachidonic acid (ARA), conjugated linoleic acid (CLA), alpha-linolenic acid, rice bran oil, wheat bran oil, interesterified oils, transesterified oils, structured lipids, and combinations thereof. Generally, the fats used in nutritional powders for formulating infant formulas and pediatric formulas provide fatty acids needed both as an energy source and for the healthy development of the infant, toddler, or child. These fats typically comprise triglycerides, although the fats may also comprise diglycerides, monoglycerides, and free fatty acids. Fatty acids provided by the fats in the nutritional powder include, but are not limited to, capric acid, lauric acid, myristic acid, palmitic acid, palmitoleic acid, stearic acid, oleic acid, linoleic acid, alpha-linolenic acid, ARA, EPA, and DHA. The nutritional powders can include any individual source of fat or combination of the various sources of fat listed above.

In those embodiments where the nutritional powder includes fat or a source of fat, the fat may be derived from various sources including, but not limited to, plants, animals, and combinations thereof. Generally, the fat may include any fat or fat source that is suitable for use in oral nutritional compositions and is otherwise compatible with any other selected ingredients or features in the nutritional composition. Non-limiting examples of suitable fat (or sources thereof) for use in the nutritional powders disclosed herein include coconut oil, fractionated coconut oil, soy oil, corn oil, olive oil, safflower oil, high oleic safflower oil, medium chain triglyceride oil (MCT oil), high gamma linolenic (GLA) safflower oil, sunflower oil, high oleic sunflower oil, palm oil, palm kernel oil, palm olein, canola oil, high oleic canola oil, marine oils, algal oils, borage oil, cottonseed oil, fungal oils, eicosapentaenoic acid (EPA), docosahexaenoic acid (DHA), arachidonic acid (ARA), conjugated linoleic acid (CLA), alpha-linolenic acid, rice bran oil, wheat bran oil, interesterified oils, transesterified oils, structured lipids, and combinations thereof. The nutritional compositions can include any individual source of fat or combination of the various sources of fat listed above.

### Optional Ingredients

In certain embodiments, the nutritional powders described herein may further comprise optional ingredients that may modify the physical, chemical, hedonic or processing characteristics of the nutritional powders or serve as additional nutritional components when used for a targeted population. Many such optional ingredients are known or otherwise suitable for use in other nutritional products and may also be used in the nutritional powders described herein, provided that such optional ingredients are safe and effective for oral administration and are compatible with the essential and other ingredients in the selected product form.

Non-limiting examples of such optional ingredients include preservatives, antioxidants, emulsifying agents, buffers, additional nutrients as described herein, colorants, flavors (natural, artificial, or both), thickening agents, flow agents, anti-caking agents, and stabilizers.

In certain embodiments, the nutritional powder further comprises minerals, non-limiting examples of which include calcium, phosphorus, magnesium, iron, zinc, manganese, copper, sodium, potassium, molybdenum, chromium, selenium, chloride, and combinations thereof.

In certain embodiments, the nutritional powder further comprises vitamins or related nutrients, non-limiting examples of which include vitamin A, vitamin D, vitamin E, vitamin K, thiamine, riboflavin, pyridoxine, vitamin B₁₂, niacin, folic acid, pantothenic acid, biotin, vitamin C, choline, inositol, salts and derivatives thereof, and combinations thereof.

In certain embodiments, the nutritional powder includes one or more masking agents to reduce or otherwise obscure bitter flavors and after taste. Suitable masking agents include natural and artificial sweeteners, natural and artificial flavors, sodium sources such as sodium chloride, and hydrocolloids, such as guar gum, xanthan gum, carrageenan, gellan gum, and combinations thereof. Generally, the amount of masking agent in the nutritional powder may vary depending upon the particular masking agent selected, other ingredients in the nutritional powder, and other nutritional powder or product target variables. Such amounts, however, most typically range from at least 0.1 wt %, including from about 0.15 wt % to about 3 wt %, and also including from about 0.18 wt % to about 2.5 wt %, by weight of the nutritional powder.

In certain embodiments, the nutritional powder includes at least one wetting agent. Generally, wetting agents act to improve and hasten the interaction between the nutritional powder and the impinging liquid, typically water, supplied by the beverage production machine. The wetting agent thus assists in quickly reconstituting the nutritional powder into a suitable liquid product. A non-limiting list of suitable wetting agents include phospholipids, mono- and diglycerides of fatty acids, diacetyl tartaric acid ester of mono- and di-glycerides (DATEM), sucrose esters, polyglycerol esters, and other emulsifiers and surfactants.

In certain embodiments, the nutritional powders include at least one anti-caking agent. Generally, these agents help to maintain the powder particles as loose, free-flowing particles with a reduced tendency to form large clumps as the powder is stored over time. Suitable anti-caking agents include silicon dioxide.

In certain embodiments, the nutritional powder comprises a compound selected from the group of leucine, beta-alanine, epigallocatechin gallate, human milk oligosaccharides, prebiotics, probiotics, nucleotides, nucleosides, carotenoids (e.g., lutein, beta-carotene, lycopene, zeaxanthin), beta-hydroxy-beta-methylbutyrate (HMB), and combinations thereof. Although calcium HMB monohydrate is the preferred source of HMB for use herein, other suitable sources may include HMB as the free acid, a salt, an anhydrous salt, an ester, a lactone, or other product forms that otherwise provide a bioavailable form of HMB from the nutritional product.

### Physical Characteristics of Nutritional Powders

The nutritional powders contained in the nutritional powder pods of the present disclosure may be characterized by certain physical characteristics. In certain embodiments, the nutritional powder contained in the nutritional powder pod has specified physical characteristics that include, but are not limited to, one or more of vibrated bulk density, particle size, wettability, and dispersibility. Generally, such characteristics may impact the reconstitution of the nutritional powder contained in the pod into a liquid product by use of a beverage production machine.

As those skilled in the art will understand, powders, including nutritional powders, typically comprise both solid material (i.e., particles) and open space (i.e., total void volume). The open space that exists in nutritional powders can be considered as sub-divided into at least two categories: space between different particles and space within a particle. Space within a particle can be considered as further subdivided into pores that have access to the surface of the particle (i.e., open pores) and pores that are located within the particle and isolated from the surface (i.e., closed pores).

Because nutritional powders typically include some amount of open space, determining the volume of a given portion of nutritional powder requires defined handling and measurement conditions. Generally, the total powder volume of a given portion of powder, i.e., the volume of the particles plus the powder void volume, can be measured directly. However, because powders are compressible, the open space between the particles generally varies depending on how the powder is or has been handled. Therefore, the conditions under which the total powder volume is measured (e.g., loose powder, compressed powder, tapped powder) must be identified. Other measurements of powder volume (e.g., envelope volume, apparent volume, and true volume) can be calculated if other measurements such as total powder volume, powder void volume, interstitial void volume, and the volume of open and closed pores in the particle are known.

The bulk powder density of a given portion of a nutritional powder is the mass of the given portion of nutritional powder per its total powder volume. As discussed above, however, nutritional powders can be compressed to varying degrees, reducing the space between particles and changing the loose bulk density of the powder. Therefore, it is important to specify the conditions under which the powder bulk density is measured. Loose bulk density and tapped bulk density are two types of bulk density measurements generally known to those skilled in the art. Several industry standard methods for measuring these two bulk density values exist, including, but not limited to, ASTM D6683-14, “Standard Test Method for Measuring Bulk Density Values of Powders and Other Bulk Solids as a Function of Compressive Stress,” and GEA Niro Analytical Method A 2 A, “Powder Bulk Density.”

One specific type of bulk density measurement is vibrated bulk density according to the test method described more fully in the Test Methods section below. The advantage of measuring vibrated bulk density is that such measurements are generally reproducible and provide consistent results between operators.

In certain embodiments, the nutritional powder contained in the nutritional powder pod of the present disclosure has a vibrated bulk density from about 0.2 g/cc to about 1 g/cc, including from about 0.25 g/cc to about 0.95 g/cc, including from about 0.3 g/cc to about 0.9 g/cc, including from about 0.35 g/cc to about 0.8 g/cc, including from about 0.35 g/cc to about 0.75 g/cc, including from about 0.35 g/cc to about 0.74 g/cc, including from about 0.4 g/cc to about 0.75 g/cc, and including about 0.5 g/cc to about 0.75 g/cc. In certain embodiments, the vibrated bulk density of the nutritional powder is about 0.2 g/cc, about 0.25 g/cc, about 0.3 g/cc, about 0.35 g/cc, about 0.4 g/cc, about 0.45 g/cc, about 0.5 g/cc, about 0.55 g/cc, about 0.6 g/cc, about 0.65 g/cc, about 0.7 g/cc, about 0.74 g/cc, about 0.75 g/cc, about 0.8 g/cc, about 0.85 g/cc, about 0.9 g/cc, about 0.95 g/cc, or about 1 g/cc. In a preferred embodiment, the nutritional powder has a vibrated bulk density of from about 0.45 g/cc to about 0.8 g/cc.

Particle size can also be an important parameter for predicting nutritional powder behavior upon reconstitution into a liquid product. Generally, particles that are too large may blend poorly into liquids, dissolve slowly, or segregate from the rest of the powder. Generally, particles that are too small may tend to agglomerate and are subject to disruptive forces such as dusting or static dispersion. Nutritional powders typically have a range of particle sizes, as well. The particle size distribution (a curve plotting the particle size versus the number, weight, area, volume, or percent of particles at that size) is another parameter that can be indicative of nutritional powder behavior upon reconstitution into a liquid product. For individual particles that are relatively spherical or globular in size, the particle size can generally be reported as the diameter of the sphere. For individual particles that have other shapes that are asymmetric (e.g., rod or flake-shaped particles) or for agglomerated particles, reporting of the particle size can be more complex.

In certain embodiments, the nutritional powder contained in the nutritional powder pod of the present disclosure has an average particle size of from about 25 μm to about 1000 μm in diameter, including from about 25 μm to about 750 μm, including from about 25 μm to about 500 μm, including from about 25 μm to about 400 μm, including from about 25 μm to about 200 μm, including from about 40 μm to about 1000 μm, including from about 40 μm to about 750 μm, including from about 40 μm to about 500 μm, including from about 40 μm to about 400 μm, including from about 40 μm to about 200 μm, including from about 60 μm to about 1000 μm, including from about 60 μm to about 750 μm, including from about 60 μm to about 500 μm, including from about 60 μm to about 600 μm, including from about 60 μm to about 400 μm, including from about 60 μm to about 200 μm, including from about 80 μm to about 1000 μm, including from about 80 μm to about 750 μm, including from about 80 μm to about 500 μm, including from about 80 μm to about 400 μm, including from about 80 μm to about 200 μm, including from about 100 μm to about 1000 μm, including from about 100 μm to about 750 μm, including from about 100 μm to about 500 μm, including from about 100 μm to about 400 μm, including from about 100 μm to about 200 μm, and including from about 150 μm to about 400 μm. Suitable average particle sizes include about 25 μm, about 40 μm, about 60 μm, about 80 μm, about 100 μm, about 125 μm, about 150 μm, about 175 μm, about 200 μm, about 250 μm, about 300 μm, about 350 μm, about 400 μm, about 450 μm, about 500 μm, about 550 μm, about 600 μm, about 650 μm, about 700 μm, about 800 μm, about 900 μm, and about 1000 μm. In a preferred embodiment, the nutritional powder contained in the nutritional powder pod of the present disclosure has an average particle size of from about 90 μm to about 200 μm.

In certain embodiments, the nutritional powder contained in the nutritional powder pod of the present disclosure has a particle size distribution where at least about 80% by number of the particles are from about 10 μm to about 2000 μm in diameter. In certain embodiments, the nutritional powder has a particle size distribution where at least about 80% by number of the particles are from about 25 μm to about 2000 μm, including from about 25 μm to about 1500 μm, including from about 25 μm to about 1000 μm, including from about 25 μm to about 500 μm, including from about 50 μm to about 2000 μm, including from about 50 μm to about 1500 μm, including from about 50 μm to about 1000 μm, including from about 50 μm to about 500 μm, including from about 75 μm to about 2000 μm, including from about 75 μm to about 1500 μm, including from about 75 μm to about 1000 μm, including from about 75 μm to about 500 μm, including from about 100 μm to about 2000 μm, including from about 100 μm to about 1500 μm, including from about 100 μm to about 1250 μm, including from about 100 μm to about 1000 μm, including from about 100 μm to about 500 μm, including from about 125 μm to about 2000 μm, including from about 125 μm to about 1500 μm, including from about 125 μm to about 1000 μm, and including from about 125 μm to about 500 μm. In preferred embodiments, at least about 60% by number of the nutritional powder particles have particle sizes from about 10 μm to about 1000 μm, including from about 10 μm to about 750 μm, including from about 10 μm to about 500 μm, including from about 25 μm to about 1000 μm, including from about 25 μm to about 750 μm, including from about 25 μm to about 500 μm, including from about 25 μm to about 400 μm, including from about 40 μm to about 1000 μm, including from about 40 μm to about 750 μm, including from about 40 μm to about 600 μm, including from about 40 μm to about 500 μm, including from about 40 μm to about 400 μm, including from about 50 μm to about 1000 μm, including from about 50 μm to about 750 μm, including from about 50 μm to about 600 μm, including from about 50 μm to about 500 μm, including from about 50 μm to about 400 μm, including from about 60 μm to about 1000 μm, including from about 60 μm to about 750 μm, including from about 60 μm to about 600 μm, including from about 60 μm to about 500 μm, including from about 60 μm to about 400 μm, including from about 70 μm to about 1000 μm, including from about 70 μm to about 750 μm, including from about 70 μm to about 600 μm, including from about 70 μm to about 500 μm, and including from about 70 μm to about 400 μm. In a preferred embodiment, the nutritional powder contained in the nutritional powder pod of the present disclosure has a particle size distribution where at least about 80% by number of the particles are from about 10 μm to about 800 μm in diameter.

Wettability is another characteristic that can affect the reconstitution of a nutritional powder into a liquid product. Generally, wettability is a measure of the ability of a nutritional powder to absorb water on the surface, to be wetted, and to penetrate the surface of still water. In certain embodiments, the nutritional powder contained in the nutritional powder pod of the present disclosure may have a wettability of about 1 second to about 200 seconds. The wettability of the nutritional powder can affect the overall flow performance of the liquid product through the beverage production machine. In certain embodiments, the wettability of the nutritional powder is measured indirectly by adding the nutritional powder to the surface of water in a container (e.g., a beaker) and recording the time it takes for the nutritional powder to fall below the surface. In certain exemplary embodiments, the nutritional powder contained in the nutritional powder pod of the present disclosure may have a wettability of about 1 second to about 200 seconds, including about 1 second to about 150 seconds, including about 5 seconds to about 125 seconds, including about 6 seconds to about 120 seconds, including about 10 seconds to about 145 seconds, including about 30 seconds to about 140 seconds, including about 60 seconds to about 130 seconds, including about 90 seconds to about 125 seconds, and including about 115 seconds to about 125 seconds.

Another characteristic that can affect the reconstitution of a nutritional powder is dispersibility. In general, dispersibility refers to the ease with which lumps and agglomerates of the nutritional powder fall apart in a liquid, such as water. The dispersibility of a nutritional powder may be evaluated by a variety of methods. In certain embodiments, the method for determining dispersibility includes the following steps: pouring a container of the reconstituted nutritional powder through an 8 inch 80 mesh sieve; adding 100 mL of slightly warm water (e.g., about 80° F. to about 95° F.) to the container and gently swirling to remove any additional clumps or residue; pouring the rinse through the 80 mesh sieve, distributing the pour around as much area of the sieve as possible; and counting the total number of particles sieved and measuring the size of each particle using a millimeter stick. In general, a nutritional powder exhibiting good dispersibility will have a minimal number (e.g., less than about 100) of undissolved particles when reconstituted.

### Nutritional Powder Reconstitution

The nutritional powder contained in the nutritional powder pods of the present disclosure exhibits generally good reconstitution (e.g., minimal clumping of the nutritional powder), within the limitations of time, temperature, and liquid volume imposed by the beverage production machine.

To ensure adequate delivery of the ingredients in the nutritional powder, the nutritional powder is reconstituted with a defined amount of liquid. Generally, the liquid is mixed with the nutritional powder of the nutritional powder pod to reconstitute the nutritional powder into a liquid product. In certain embodiments, the liquid is passed into and through the nutritional powder pod, mixing with the nutritional powder to reconstitute it into a liquid product. In certain embodiments, the liquid is passed into the nutritional powder pod, mixing with the nutritional powder to reconstitute it into a liquid product. In certain embodiments, the liquid is injected into the nutritional powder pod, mixing with the nutritional product to reconstitute it into a liquid product. In certain embodiments, the liquid product (i.e., the reconstituted nutritional powder) is delivered in a sanitary manner to a receiving container (e.g., a bottle, a sippy cup, a mug), and the pod is thereafter discarded.

In certain embodiments, the nutritional powder is reconstituted into a liquid product at a rate of from about 10 grams to about 150 grams of powder per 200 mL of liquid, including from about 20 g/200 mL to about 125 g/200 mL, including from about 20 g/200 mL to about 100 g/200 mL, including from about 20 g/200 mL to about 80 g/200 mL, including from about 20 g/200 mL to about 65 g/200 mL, including from about 20 g/200 mL to about 50 g/200 mL, including from about 25 g/200 mL to about 150 g/200 mL, including from about 25 g/200 mL to about 125 g/200 mL, including from about 25 g/200 mL to about 100 g/200 mL, including from about 25 g/200 mL to about 80 g/200 mL, including from about 25 g/200 mL to about 65 g/200 mL, including from about 25 g/200 mL to about 50 g/200 mL, including from about 40 g/200 mL to about 150 g/200 mL, including from about 40 g/200 mL to about 125 g/200 mL, including from about 40 g/200 mL to about 100 g/200 mL, including from about 40 g/200 mL to about 80 g/200 mL, including from about 40 g/200 mL to about 65 g/200 mL, including from about 40 g/200 mL to about 50 g/200 mL, including about 50 g/200 mL to about 150 g/200 mL, including about 50 g/200 mL to about 125 g/200 mL, including about 50 g/200 mL to about 100 g/200 mL, including from about 50 g/200 mL to about 80 g/200 mL, including from about 50 g/200 mL to about 65 g/200 mL, including from about 60 g/200 mL to about 150 g/200 mL, including from about 60 g/200 mL to about 125 g/200 mL, and including about 60 g/200 mL to about 100 g/200 mL. The nutritional powders may also be reconstituted at a rate of 10 grams of powder per 200 mL of liquid, 20 g/200 mL, 25 g/200 mL, 30 g/200 mL, 40 g/200 mL, 50 g/200 mL, 60 g/200 mL, 65 g/200 mL, 75 g/200 mL, 80 g/200 mL, 100 g/200 mL, 125 g/200 mL, and 150 g/200 mL.

Generally, when preparing a liquid product from a nutritional powder pod, it is desirable that the nutritional powder be accurately and fully incorporated into the liquid product. It can be undesirable, for instance, for there to be a residue of dry nutritional powder left at the bottom of a container or for the nutritional powder to form clumps that fail to reconstitute in the liquid product. This is particularly important with infant formulas, because these formulas typically provide the sole source or a supplemental source of nourishment to the infant. Generally, when the nutritional powder is an infant formula, the nutritional powder must be fully reconstituted so the infant receives a full serving of nutrients and calories provided by the infant formula. Additionally, any unreconstituted nutritional powder left within the nutritional powder pod is typically discarded, which is wasteful both economically and environmentally. As well, within a beverage production machine, any unreconstituted powder may create clumps that can deposit within or clog the inner workings of the machine, which can create sites for microbial growth and contamination or cause machine failure.

For these reasons, in certain embodiments, the nutritional powder in the nutritional powder pod is essentially reconstituted into the liquid product by a beverage production machine. In certain embodiments, “essentially reconstituted” means that at least 75% (i.e., 75% to 100%) of the mass of the nutritional powder is reconstituted into the liquid product, including at least about 75%, at least about 80%, at least about 85%, at least about 90%, at least about 92%, at least about 95%, at least about 98%, at least about 100%, and about 75 to about 100%, about 75 to about 98%, about 75 to about 95%, about 75 to about 90%, about 75 to about 85%, about 80 to about 100%, about 80 to about 98%, about 80 to about 95%, about 80 to about 90%, about 85 to about 100%, about 85 to about 98%, about 85 to about 95%, about 90 to about 100%, about 90 to about 98%, about 90 to about 95%, about 92 to about 100%, about 92 to about 98%, about 95 to about 100%, and about 95 to about 98% of the mass of the nutritional powder.

Generally a beverage production machine places certain limitations on the conditions (e.g., liquid temperature, pressure) under which reconstitution takes place. For example, the beverage production machine may inject a specified volume of liquid at a specified temperature into the nutritional powder pod. In certain exemplary embodiments, liquid is mixed with the nutritional powder in the pod at a temperature between about 5° C. and about 60° C., including from about 5° C. to about 50° C., about 5° C. to about 40° C., from about 5° C. to about 30° C., from about 5° C. to about 20° C., from about 5° C. to about 10° C., from about 10° C. to about 60° C., from about 20° C. to about 60° C., from about 30° C. to about 60° C., from about 40° C. to about 60° C. and also including from about 50° C. to about 60° C. In certain of the same or other exemplary embodiments, liquid is mixed with the nutritional powder in the pod at a pressure ranging from about 0.3 bar to about 15 bar, including from about 0.3 bar to about 10 bar, from about 0.3 bar to about 7 bar, from about 0.3 bar to about 5 bar, from about 0.3 bar to about 2 bar, from about 0.3 bar to about 1 bar, from about 1 bar to about 10 bar, from about 2 bar to about 10 bar, from about 3 bar to about 10 bar, from about 5 bar to about 10 bar, and also including from about 2 bar to about 7 bar.

In certain exemplary embodiments, the total amount of liquid used to reconstitute the liquid product is within the range of about 0.17 fluid ounce to about 34 fluid ounces (about 5 mL to about 1,000 mL), including about 0.5 fluid ounce to about 34 fluid ounces (about 15 mL to about 1,000 mL), including about 1 fluid ounce to about 17 fluid ounces (about 30 mL to about 500 mL), including about 1 fluid ounce (about 30 mL), including about 2 fluid ounces (about 60 mL), including about 4 fluid ounces (about 120 mL), including about 7 fluid ounces (about 207 mL), including about 8 fluid ounces (about 240 mL), including about 10 fluid ounces (about 296 mL), including about 12 fluid ounces (about 355 mL), including about 14 fluid ounces (about 414 mL), including about 17 fluid ounces (about 500 mL), and also including about 34 fluid ounces (about 1,000 mL). Accordingly, in certain exemplary embodiments, the volume of liquid product dispensed from the beverage product machine is within the range of about 0.17 fluid ounce to about 34 fluid ounces (about 5 mL to about 1,000 mL), including about 0.5 fluid ounce to about 34 fluid ounces (about 15 mL to about 1,000 mL), including about 1 fluid ounce to about 17 fluid ounces (about 30 mL to about 500 mL), including about 1 fluid ounce (about 30 mL), including about 2 fluid ounces (about 60 mL), including about 4 fluid ounces (about 120 mL), including about 7 fluid ounces (about 207 mL), including about 8 fluid ounces (about 240 mL), including about 10 fluid ounces (about 296 mL), including about 12 fluid ounces (about 355 mL), including about 14 fluid ounces (about 414 mL), including about 17 fluid ounces (about 500 mL), and also including about 34 fluid ounces (about 1,000 mL).

In certain exemplary embodiments, the liquid product dispensed from the beverage production machine falls within the temperature range of about 5° C. to about 60° C., including about 5° C. to about 50° C., about 5° C. to about 40° C., including about 5° C. to about 30° C., including about 5° C. to about 20° C., including about 5° C. to about 10° C., including about 10° C. to about 60° C., including about 20° C. to about 60° C., including about 30° C. to about 60° C., including about 40° C. to about 60° C., and also including about 50° C. to about 60° C.

In certain exemplary embodiments, the nutritional powder is reconstituted within a defined period of time to render the liquid nutritional product suitable for oral consumption. In certain exemplary embodiments, the nutritional powder is reconstituted within a time ranging from about 10 seconds to about 300 seconds, including a range of about 30 seconds to about 200 seconds, including a range of about 30 seconds to about 120 seconds, including a time of less than about 60 seconds (i.e., about 5 seconds to about 60 seconds), including a time of less than about 50 seconds, including a time of less than about 40 seconds, including a time of less than about 30 seconds. In certain exemplary embodiments, the nutritional powder is reconstituted within a time of from about 20 seconds to about 45 seconds.

The reconstitution of a nutritional powder may be determined by a variety of methods. One particular method for testing the reconstitution of a nutritional powder is described below in the Nutritional Powder Reconstitution Test section. A nutritional powder is deemed to have good reconstitution if the reconstitution yield is at least about 75 wt. % of the nutritional powder, including at least about 80 wt. %, at least about 85 wt. %, at least about 90 wt. %, at least about 92 wt. %, at least about 95 wt. %, at least about 97 wt. %, at least about 98 wt. %, or at least about 99 wt. % of the nutritional powder. In certain embodiments, the nutritional powder contained in the nutritional powder pod of the present disclosure has a reconstitution yield of at least about 75 wt. %, including at least about 80 wt. %, at least about 85 wt. %, at least about 90 wt. %, at least about 92 wt. %, at least about 95 wt. %, at least about 97 wt. %, at least about 98 wt. %, or at least about 99 wt. % of the nutritional powder. In certain embodiments, the nutritional powder contained in the nutritional powder pod of the present disclosure has a reconstitution yield of from about 80 wt. % to about 100 wt. %.

The Nutritional Powder Reconstitution Test can also be used to determine the rate of reconstitution of the nutritional powder contained in the nutritional powder pods of the present disclosure. In certain embodiments, the nutritional powder contained in the nutritional powder pod has a rate of reconstitution of from about 0.1 mg/g-sec to about 25 mg/g-sec. In certain exemplary embodiments, the nutritional powder has a rate of reconstitution of from about 0.5 mg/g-sec to about 25 mg/g-sec, including from about 1 mg/g-sec to about 25 mg/g-sec, from about 5 mg/g-sec to about 25 mg/g-sec, from about 10 mg/g-sec to about 25 mg/g-sec, from about 15 mg/g-sec to about 25 mg/g-sec, and also including from about 20 mg/g-sec to about 25 mg/g-sec. In certain exemplary embodiments, the nutritional powder has a rate of reconstitution of from about 1 mg/g-sec to about 15 mg/g-sec, including from about 1.5 mg/g-sec to about 15 mg/g-sec, from about 2 mg/g-sec to about 15 mg/g-sec, from about 2.5 mg/g-sec to about 15 mg/g-sec, and also including from about 5 mg/g-sec to about 15 mg/g-sec. Without being bound by theory, it is believed that as a result of being within the specified rate of reconstitution, the nutritional powder contained within the nutritional powder pod exhibits generally good reconstitution (e.g., minimal clumping of the nutritional powder) when the nutritional powder pod is used in a beverage production machine.

In certain embodiments, the liquid product from the reconstituted nutritional powder may have a Hunter Lab “L” value within a range of from about 20 to about 100. The Hunter Lab “L” value is a measurement of the lightness of the liquid product. The Hunter Lab “L” value of the liquid product can be measured by a spectrophotometer, which allows quantitative measurement of the reflection or transmission properties of the liquid product as a function of wavelength. In certain embodiments, the Hunter Lab “L” value of the liquid product may be within a range of from about 25 to about 100, including from about 30 to about 95, from about 35 to about 90, from about 40 to about 85, from about 45 to about 80, from about 50 to about 75, from about 55 to about 70, and also including from about 60 to about 65. In certain embodiments, the Hunter Lab “L” value of the liquid product may be within a range of from about 30 to about 100, including from about 30 to about 90, from about 30 to about 80, from about 30 to about 70, from about 30 to about 60, from about 30 to about 50, and also including from about 30 to about 40.

In certain embodiments, the liquid product may have a Hunter Lab “a” value within a range of from about −5 to about 1. The Hunter Lab “a” value is a measurement of the color-opponent dimension of the liquid product. The Hunter Lab “a” value of the liquid product can be measured by a spectrophotometer, which allows quantitative measurement of the reflection or transmission properties of the liquid product as a function of wavelength. In certain embodiments, the Hunter Lab “a” value of the liquid product may be within a range of from about −4.5 to about 1, including from about −4 to about 1, from about −3 to about 1, from about −2 to about 1, from about −1 to about 1, and also including from about 0 to about 1. In certain embodiments, the Hunter Lab “a” value of the liquid product may be within a range of from about −5 to about 0.5, including from about −5 to about 0, from about −5 to about −0.5, from about −5 to about −1, from about −5 to about −2, from about −5 to about −3, and also including from about −5 to about −4.

In certain embodiments, the liquid product may have a Hunter Lab “b” value with a range of from about 1 to about 30. The Hunter Lab “b” value is a measurement of the color-opponent dimension of the liquid product. The Hunter Lab “b” value of the liquid product can be measured by a spectrophotometer, which allows quantitative measurement of the reflection or transmission properties of the liquid product as a function of wavelength. In certain embodiments, the Hunter Lab “b” value of the liquid product may be within a range of about 1 to about 30, including from about 5 to about 25, and also including from about 10 to about 20. In certain embodiments, the Hunter Lab “b” value of the liquid product may be within a range of about 10 to about 30, including from about 15 to about 30, from about 20 to about 30, and also including from about 25 to about 30. In certain embodiments, the Hunter Lab “b” value of the liquid product may be within a range of about 1 to about 20, including from about 1 to about 15, from about 5 to about 15, and also including from about 5 to about 10.

### Methods of Manufacture

As discussed above, certain embodiments of the present disclosure relate to methods of manufacturing a nutritional powder pod suitable for use in a beverage production machine. In one exemplary embodiment, the method comprises providing a base nutritional powder, dry blending a carbohydrate into the base nutritional powder to form a final nutritional powder, and enclosing the final nutritional powder into a pod, thereby forming a nutritional powder pod. At least about 5 wt % of the carbohydrate in the final nutritional powder is provided by a dry blended carbohydrate.

In certain embodiments, the base nutritional powder comprises a carbohydrate, a protein, and a fat. In certain embodiments, the base nutritional powder comprises a protein, a fat, and is substantially free of carbohydrates. The phrase “substantially free of carbohydrates” in this context refers to a base nutritional powder that is prepared without the addition of an individual carbohydrate ingredient (e.g., sucrose, lactose), but which may contain some amount of carbohydrates by virtue of carbohydrates being inherently present in another ingredient (e.g., a protein source). In such embodiments where the base nutritional powder is substantially free of carbohydrates, the carbohydrates in the final nutritional powder are provided by a dry blended carbohydrate. In certain embodiments where the base nutritional powder is substantially free of carbohydrates, from about 85% to about 100% by weight of the carbohydrates in the final nutritional powder are provided by a dry blended carbohydrate. In certain embodiments, the base nutritional powder comprises a protein. In certain embodiments, the base nutritional powder comprises a fat. In certain embodiments, the protein, fat, or both present in the final nutritional powder are provided by the base nutritional powder. Any of the carbohydrates, proteins, and fats described herein may be present in the base nutritional powder.

In certain embodiments, the base nutritional powder is a spray dried powder. Accordingly, in certain such embodiments, the base nutritional powder utilized to form the final nutritional powder is prepared utilizing a spray drying process. In general, a spray drying process to produce the base nutritional powder will typically involve the initial formation of an aqueous slurry containing macronutrients, stabilizers, formulation aids, vitamins, minerals, or combinations thereof. The slurry is then emulsified, pasteurized, homogenized, and cooled. Various other solutions, mixtures, or other materials may be added to the resulting emulsion before, during, or after further processing. This emulsion can then be further diluted, heat-treated, and subsequently dried via spray drying to produce the base nutritional powder.

In certain embodiments, the base nutritional powder is an extruded powder. Accordingly, in certain such embodiments, the base nutritional powder utilized to form the final nutritional powder is prepared utilizing an extrusion process.

In certain embodiments, the base nutritional powder is agglomerated. The term “agglomerated” as used herein, unless otherwise specified, refers to a nutritional powder that is processed such that individual powder particles are fused together to form porous aggregates of powder particles. The agglomerated nutritional powders described herein may be produced according to well known processes including, but not limited to, rewetting agglomeration, fluid-bed agglomeration, and instantization by spray lecithination.

In accordance with the exemplary methods described herein, a carbohydrate is dry blended into the base nutritional powder to form a final nutritional powder. In certain embodiments, the base nutritional powder is provided in a suitable blender (or mixer), and a carbohydrate is added to the blender, wherein the blender operates to thoroughly mix the carbohydrate into the base nutritional powder to form a homogeneous final nutritional powder. In certain embodiments, an additional component, such as a flavor or powdered lecithin, is added to the blender along with the base nutritional powder and the carbohydrate to form the final nutritional powder. In certain embodiments, the final nutritional powder is agglomerated. The amount of carbohydrates dry blended into the base nutritional powder such that at least about 5 wt % of the total carbohydrates in final nutritional powder is provided by the dry blended carbohydrates may be readily determined by one of skill in the art, and will depend on the amount of carbohydrates present in the base nutritional powder.

Without being bound by theory, it is believed that the process of dry blending a carbohydrate into a base nutritional powder to form a final nutritional powder may provide a number of benefits. In addition to optimal reconstitution characteristics, the amount of carbohydrate that is introduced into the one or more slurries used to produce the base nutritional powder can be significantly reduced, while maintaining the (same) overall carbohydrate content in the final nutritional powder. This reduction in the “up front” addition of the carbohydrate can result in reduced overall manufacturing costs as the drying time for the mixture of slurries is reduced and equipment maintenance costs may also be reduced.

In accordance with the exemplary methods described herein, the final nutritional powder is enclosed into a pod to form a nutritional powder pod. For purposes of the method, the pod may be configured according to any of the embodiments of the pod as previously described herein. Similarly, the final nutritional powder may be formulated according to any of the embodiments of the nutritional powder as previously described herein. In certain embodiments, the step of enclosing the final nutritional powder into a pod comprises dispensing a predetermined amount of the final nutritional powder into the pod, and closing the pod containing the final nutritional powder. Such enclosing step may be accomplished utilizing conventional packaging equipment, such as powder hoppers and automated powder dispensers. In certain embodiments, the step of closing the pod comprises hermetically sealing the pod containing the final nutritional powder. Conventional sealing equipment may be used to hermetically seal the pod.

In addition to describing the particular elements comprising the nutritional powder pod, the nutritional powder pod may also be described according to a specified process for making the nutritional powder pod. For example, in one exemplary embodiment, a nutritional powder pod is made according to the following process: providing a base nutritional powder, dry blending a carbohydrate into the base nutritional powder to form a final nutritional powder such that at least about 5 wt % of the carbohydrate in the final nutritional powder is provided by the dry blending of the carbohydrate, and enclosing the final nutritional powder into a pod, thereby forming a nutritional powder pod. For purposes of this process, the pod may be configured according to any of the embodiments of the pod as previously described herein. Similarly, the final nutritional powder may be formulated according to any of the embodiments of the nutritional powder as previously described herein.

### Methods of Use

The exemplary nutritional powder pods described herein are generally designed and configured for use with a beverage production machine to prepare a liquid product. In one exemplary embodiment, a liquid product is prepared according to the following process: using a nutritional powder pod with a beverage production machine to mix a liquid with the nutritional powder pod such that the nutritional powder contained therein is reconstituted, thereby producing a liquid product.

In certain embodiments, an individual consumes one or more servings of the liquid product made using the nutritional powder pods in a beverage production machine. The serving size may be different for different types of individuals, depending on one or more factors including, but not limited to, age, body mass, gender, species, or health.

In these embodiments, an individual desirably consumes at least one serving of the liquid product made using the nutritional powder pods per day, and in some embodiments, may consume two, three, or even more servings per day. Each serving is desirably administered as a single undivided serving, although the serving may also be divided into two or more partial or divided servings to be taken at two or more times during the day.

The methods of the present disclosure include continuous day after day administration of the liquid product made using the nutritional powder pods, as well as periodic or limited administration of the liquid product made using the nutritional powder pods, although continuous day after day administration of the liquid product is generally desirable. The liquid product made using the nutritional powder pods may be used by infants, toddlers, children, and adults.

### Test Methods

The following discussion of test methods should be considered to be exemplary only and not construed to be limiting upon the present disclosure. Specifically, other test methods and variations of the provided test methods may be used, in certain embodiments, to measure the same physical properties or characteristics of a nutritional powder.

### Vibrated Bulk Density Test

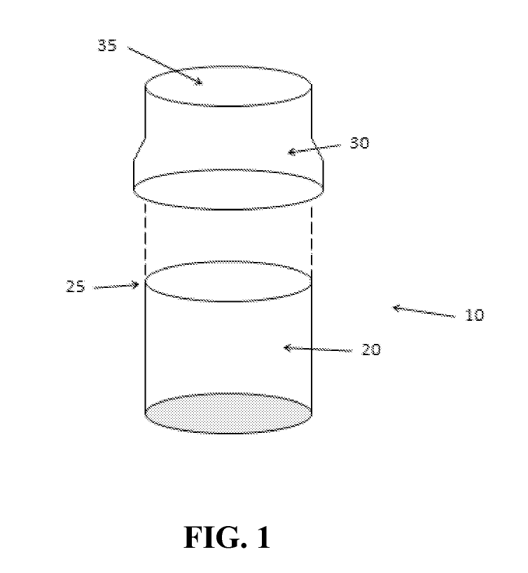

Generally, the following test method is used to measure the bulk density of a powder that has been compressed by vibration in a reproducible manner. More specifically, the test method uses a test cylinder having a top portion and bottom portion capable of being separated. One exemplary test cylinder is a Plexiglas® bulk density test cylinder 10, illustrated in FIG. 1, which comprises a calibrated bottom portion 20 and a top portion 30. Preferably, the volume of the bottom portion 20 of the test cylinder 10 is calibrated and permanently labeled thereon. The calibration may be in any appropriate volumetric measurement, e.g., cubic centimeters (“cc”) or milliliters (“mL”).

The bottom portion 20 of the test cylinder 10 is weighed to determine the tare weight. The top portion 30 of the test cylinder is then placed on top of the bottom portion 20 of the test cylinder. The test cylinder 10 is then filled to near overflowing with the test powder (e.g., through the opening 35 at the top of the top portion 30). Care should be taken to avoid compressing the powder as the cylinder is filled. A powder funnel may be used to simplify this task. Visible air gaps or unfilled portions of the cylinder should be avoided.

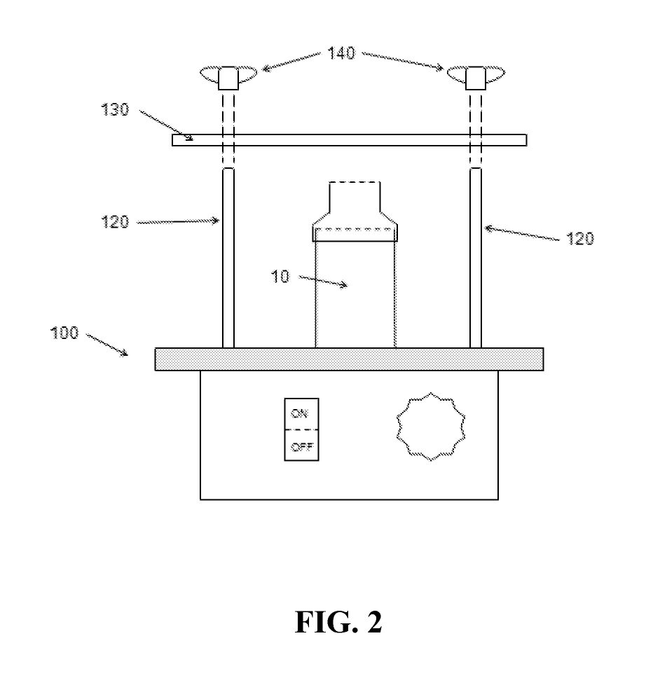

The test cylinder 10 is placed on or in a vibration apparatus (e.g., a modified Syntron® J-1A portable jogger 100, as illustrated in FIG. 2). The test cylinder 10 is secured to the vibration apparatus by being placed between the clamping rods 120 and clamped in place with the clamping strap 130 and wing nuts 140. The modified vibration table 100 is set to a predetermined amplitude (e.g., amplitude=0.04-0.045 in, frequency=60 Hz), and the test cylinder is vibrated for a 60-second vibration cycle.

When the vibration cycle is complete, the test cylinder is unclamped and removed from the modified vibration table 100. Any excess powder is removed and the top of the cylinder is removed. For example, when using the test cylinder 10 illustrated in FIG. 1, the top section 30 of the test cylinder 10 is carefully removed over an appropriate waste receptacle. Using a spatula, the excess powder sample above the mouth 25 of the bottom section 20 of the test cylinder is struck off such that the powder contained in the bottom section 20 is smooth and flush with the mouth 25. Using a dry cloth, any powder clinging to the outside of the bottom section 20 is removed.

The bottom section of the test cylinder with the vibrated powder sample is then weighed to determine the gross weight. The vibrated bulk density of the powder is calculated as follows:

$$\frac{[ Gross weight ( g ) ] - [ Tare weight ( g ) ]}{[ Calibrated test cyclinder volume ( cc ) ]} = Vibrated Bulk Density ( g \text{/} cc )$$

### Particle Size and Particle Size Distribution by Laser Diffraction

In certain embodiments, laser diffraction is used to measure the particle size and particle size distribution for the nutritional powder. The powder is dispersed into an air stream and passed through a laser beam. The particles diffract the photons of the laser at different angles, depending on the size of the particle. A detector with semicircular ring elements detects the diffracted photons. The intensity of the detected photons and the angle of detection are used to calculate the number, area, and volume-weighted particle size in the sample, and a particle size distribution can be determined. From this distribution, an average particle size, based on the number, area, or volume of particles, can also be calculated.

### Nutritional Powder Reconstitution Test

Generally, a nutritional powder reconstitution test can be used to evaluate how thoroughly the nutritional powder is reconstituted under the operating conditions of a beverage production machine, and to determine a corresponding reconstitution rate.

According to this test, multiple same size portions (e.g., triplicate portions of 2-5 g samples) are taken from the same batch of the nutritional powder to be tested. These portions are weighed both before and after drying by conventional drying techniques (e.g., convection or infrared) to determine the initial moisture content of each portion (i.e., the weight lost to drying). The average initial moisture content (by weight) is then determined by averaging the results from the multiple portions.

Pre-weighed portions of each test sample of the nutritional powder are enclosed in resealable nutritional powder pods for the reconstitution testing. Example amounts of the test samples of the nutritional powder range from 2-150 grams.

The test system may be a working beverage production machine, or a model system configured to simulate a beverage production machine and operating under specified conditions. The test system is configured to accommodate and operate under the operating conditions of a beverage product machine, as follows. The pressure within the pod, as well as the temperature of the water that contacts the nutritional powder and the amount of water flowing through the pod are controlled and measurable.

For the reconstitution test, the pod containing the test sample of the nutritional powder is inserted into the test system, and the system is set to deliver a certain amount of water (e.g., about 25-500 mL) at a certain temperature (e.g., in the range of 5-60° C.) under a certain pressure (e.g., 0.3-15 bar, or approximately 5-217 psia) into and through the pod. Under this test, the ratio of powder weight (grams) to water weight (grams) (where the density of water is taken to be 1 g/mL) is lower than 1:1 (e.g., 1:1.1, 1:1.2, 1:1.3, 1:2, 1:3, 1:5, etc.). In other words, relatively less powder (in grams) is used as compared to the amount (in grams) of water. A sufficiently large collection bottle is placed under the dispenser of the test system to receive the homogeneous liquid product output. The test system is started, and the homogeneous liquid product is collected in the collection bottle.

Reconstitution Time—

During the nutritional powder reconstitution test, described above, the reconstitution time is determined by measuring the time that elapses from the initiation time until the reconstituted product is observed to be fully delivered to the collection bottle.

Rate of Reconstitution—

The rate of reconstitution is determined using the general test method and system for the Nutritional Powder Reconstitution Test described above, except that the reconstituted liquid product is collected over 5-second intervals in sequentially-numbered collection vessels. The mass of collected powder in the reconstituted liquid product in each collection vessel is measured using any standard drying technique (e.g., forced air oven, infrared heating, microwave drying, etc.) to remove the water from the collected reconstituted liquid product. The rate of reconstitution is then determined by dividing the weight of total reconstituted solids, i.e., the mass of collected powder (milligram) by the original mass of nutritional powder in the pod (gram) and the collection time interval (seconds), thereby resulting in a “milligram/gram-second” value.

Reconstitution Yield—

The reconstitution yield is determined by measuring the residual powder in the pod after the general test method and system described for the Nutritional Powder Reconstitution Test described above is completed. A known amount of water is dispensed into the pod and mixed with the remaining powder which is emptied into a collection vessel. The total solids of this rinse water is measured using any standard drying technique (e.g., via a forced air oven or microwave drying technique) to remove the water from the product.

To determine the powder remaining in the pod, the grams of total solids in the rinse water are divided by the percentage of total solids in the powder. The reconstitution yield is then determined by subtracting the ratio of powder remaining in the pod to powder put in the pod from 1. The reconstituted yield can be reported in the units of “milligram/milligram” (mg/mg) or converted to a percentage (e.g., milligram/milligram×100%).

### EXAMPLES

The following examples describe and demonstrate exemplary embodiments of the nutritional powders described herein. The exemplary embodiments are provided solely for the purpose of illustration and are not to be construed as limitations of the present disclosure, as many variations thereof are possible without departing from the spirit and scope of the present disclosure. The exemplary nutritional powders may be prepared in accordance with the methods described herein.

Example 1A, shown in Table 3 below, illustrates an exemplary nutritional powder that is formulated as an infant formula. All ingredient amounts are listed as pounds (lb) per 1,000 lb batch of nutritional powder.

TABLE 3

| | |
|---|---|
| | Example 1A |
| Ingredients | (Quantity (lb) per 1,000 lb batch) |

Base Nutritional Powder Ingredients

| | |
|---|---|
| Non-Fat Dry Milk | 203.16 |
| Lactose | 188.31 |
| High Oleic Safflower Oil | 115.89 |
| Soy Oil | 88.04 |
| Coconut Oil | 81.09 |
| Galactooligosaccharides | 66.87 |
| Whey Protein Concentrate | 50.00 |
| Potassium Citrate | 9.16 |
| Lecithin | 5.00 |
| Calcium Carbonate | 4.03 |
| Arachidonic Acid | 3.69 |
| Potassium Chloride | 1.25 |
| Docosahexaenoic Acid | 1.11 |
| Magnesium Chloride | 1.03 |
| Sodium Chloride | 0.59 |
| Choline Chloride | 0.43 |
| Vitamin ADEK | 0.39 |
| Ascorbyl Palmitate | 0.37 |
| Mixed Carotenoid Premix | 0.35 |
| Mixed Tocopherols | 0.16 |
| Ascorbic Acid | 1.27 |
| Riboflavin | 0.003 |
| L-Carnitine | 0.026 |
| Vitamin/Mineral Premix | 1.11 |
| Ferrous Sulfate | 0.45 |
| Nucleotide/Choline Premix | 2.33 |

Dry Blended Ingredients

| | |
|---|---|
| Lactose | 200.00 |

Example 1B, shown in Table 4 below, illustrates an exemplary nutritional powder that is formulated as a soy-protein containing infant formula. All ingredient amounts are listed as kilogram (kg) per 1,000 kg batch of nutritional powder.

TABLE 4

| | |
|---|---|
| | Example 1B |
| | (Quantity (kg) per |
| Ingredients | 1,000 kg batch) |

Base Nutritional Powder Ingredients

| Soy Protein Isolate (5% DH) | 144.8 | |
|---|---|---|
| Sunflower Oil | 112.5 | |
| Sucrose | 98.3 | |
| Soy Oil | 83.9 | |
| Coconut Oil | 75.6 | |
| Potassium Citrate | 16.5 | |
| Calcium Phosphate | 16.4 | |
| Sodium Chloride | 3.8 | |
| Arachidonic Acid Oil | 3 | |
| Magnesium Chloride | 2.8 | |
| L-Methionine | 1.7 | |
| Ascorbic Acid | 1.1 | |
| Docosahexaenoic Acid Oil | 1.1 | |
| Lutein | 945.0 | mg |
| Choline Chloride | 507.7 | g |
| Taurine | 457.5 | g |
| Inositol | 353.0 | g |
| Ascorbyl Palmitate | 347.5 | g |
| Ferrous Sulfate | 319.2 | g |
| Mixed Tocopherols | 157.2 | g |
| L-Carnitine | 112.7 | g |
| Niacinamide | 97.9 | g |
| D-Alpha-Tocopheryl Acetate | 78.8 | g |
| Calcium D-Pantothenate | 58.7 | g |
| Zinc | 56.0 | g |
| Iron | 16.9 | g |
| Thiamine | 15.2 | g |
| Vitamin A Palmitate | 14.8 | g |
| Copper | 7.2 | g |
| Riboflavin | 6.7 | g |
| Pyridoxine Hydrochloride | 6.1 | g |
| Folic Acid | 2.1 | g |
| Potassium Iodide | 1.1 | g |
| Phylloquinone | 857.1 | mg |
| Vitamin D₃ | 47 | mg |
| Lycopene | 980.0 | mg |
| Biotin | 592.5 | mg |
| Beta-Carotene | 215.6 | mg |
| Selenium | 147.0 | mg |
| Cyanocobalamin | 71.3 | mg |

Dry Blended Ingredients

| | |
|---|---|
| Corn Syrup Solids | 375 |
| Fructooligosaccharides | 17 |

Example 2, shown in Table 5 below, illustrates an exemplary nutritional powder that is formulated as a pediatric formula. All ingredient amounts are listed as kilogram (kg) per 1,000 kg batch of nutritional powder.

TABLE 5

| | |
|---|---|
| | Example 2 |
| | (Quantity (kg) per |
| Ingredients | 1,000 kg batch) |

Base Nutritional Powder Ingredients

| Milk Protein Concentrate (80%) | 121.1 | |
|---|---|---|
| Soy Oil | 82.0 | |
| High Oleic Sunflower Oil | 69.5 | |
| Whey Protein Concentrate | 27.9 | |
| MCT Oil | 26.7 | |
| Soy Protein Isolate | 24.4 | |
| Potassium Citrate | 7.1 | |
| Flavor | 6.7 | |
| Magnesium Phosphate Dibasic | 5.7 | |
| Potassium Chloride | 4.3 | |
| Sodium Chloride | 3.7 | |
| Tricalcium Phosphate | 3.2 | |
| Vitamin/Mineral Premix | 2.5 | |
| Docosahexaenoic Acid | 2.0 | |
| Choline Chloride | 1.7 | |
| Potassium Phosphate Monobasic | 1.5 | |
| Calcium Carbonate | 1.4 | |
| Potassium Phosphate Dibasic | 1.2 | |
| Ascorbic Acid | 871.7 | grams |
| Arachidonic Acid | 645.0 | grams |
| Ascorbyl Palmitate | 502.1 | grams |
| Vitamin ADEK Premix | 176.5 | grams |
| Lactobacillus Acidophilus | 100.0 | grams |
| Tocopherol Antioxidant | 83.7 | grams |
| dl-Alpha Tocopheryl Acetate | 49.5 | grams |
| Bifidobacterium Lactis | 35.0 | grams |
| Vitamin A Palmitate | 1.2 | grams |
| Potassium Iodide | 89.2 | milligrams |

| | |
|---|---|
| Sodium Citrate | As Needed |
| Magnesium Chloride | As Needed |
| Citric Acid (processing aid) | As Needed |
| Potassium Hydroxide (processing aid) | As Needed |

Dry Blended Ingredients

| | |
|---|---|
| Maltodextrin | 300.0 |
| Sucrose | 288.0 |
| Fructooligosaccharides | 22.9 |

Example 3, shown in Table 6 below, illustrates an exemplary nutritional powder that is formulated as an adult nutritional product. All ingredient amounts are listed as kilogram (kg) per 1,000 kg batch of nutritional powder.

TABLE 6

| | |
|---|---|
| | Example 3 |
| | (Quantity (kg) per |
| Ingredients | 1,000 kg batch) |

Base Nutritional Powder Ingredients

| Milk Protein Concentrate (80%) | 133 | |
|---|---|---|
| High Oleic Sunflower Oil | 85.3 | |
| Soy Protein Isolate | 54.7 | |
| Soy Oil | 38.5 | |
| Canola Oil | 13.8 | |
| Sodium Citrate | 12.8 | |
| Potassium Citrate | 11.7 | |
| Flavor | 7.3 | |
| Magnesium Chloride | 6.3 | |
| Potassium Chloride | 4.2 | |
| Tricalcium Phosphate | 3.5 | |
| Choline Chloride | 1.7 | |
| Ascorbic Acid | 880.0 | grams |
| Calcium Carbonate | 553.0 | grams |
| Water Soluble Vitamin Premix | 485.0 | grams |
| Ultra Trace Mineral/Trace Mineral Premix | 430.0 | grams |
| Ascorbyl Palmitate | 164.6 | grams |
| Vitamin ADEK Premix | 146.7 | grams |
| Tocopherol Antioxidant | 82.3 | grams |
| dl-Alpha Tocopheryl Acetate | 44.7 | grams |
| Beta Carotene (30%) | 5.5 | grams |
| Manganese Sulfate | 3.7 | grams |
| Thiamin Hydrochloride | 2.5 | grams |
| Riboflavin | 1.5 | grams |
| Vitamin A Palmitate | 1.2 | grams |
| Potassium Iodide | 913.3 | milligrams |

| | |
|---|---|
| Magnesium Sulfate | As Needed |
| Copper Sulfate | As Needed |
| Citric Acid (processing aid) | As Needed |
| Potassium Hydroxide (processing aid) | As Needed |

Dry Blended Ingredients

| | |
|---|---|
| Maltodextrin | 268.7 |
| Corn Syrup Solids | 192.7 |
| Sucrose | 112.4 |
| Fructooligosaccharides | 21.9 |
| Inulin | 21.9 |

Examples 4-15 illustrate certain physical characteristics of exemplary nutritional powders of the present disclosures. The nutritional powders were prepared according to the methods described previously. The nutritional powders included infant, toddler, and adult formulations.

The exemplary nutritional powders of Examples 4-15 were tested to determine the vibrated bulk density in accordance with the Vibrated Bulk Density Test method described above. The results of such testing are shown in Table 7.

TABLE 7

| | | | Percentage | |
|---|---|---|---|---|
| | | | of Total | |
| | | Dry Blended | Carbohydrates | Vibrated |
| | | Carbohydrates | Dry | Bulk |
| | Sample | in | Blended in | Density |
| Example | Code* | Powder (wt %) | Powder | (g/cc) |
| Example 4 | SD/DB-1B | 20% | 40% | 0.63 |
| Example 5 | SD/DB-2B | 20% | 40% | 0.59 |
| Example 6 | SD/DB-5A | 16% | 29% | 0.55 |
| Example 7 | SD/DB-4C | 15% | 27% | 0.55 |
| Example 8 | SD/DB-7C | 15% | 26% | 0.67 |
| Example 9 | SD/DB-5D | 15% | 26% | 0.57 |
| Example 10 | SD/DB-8C | 20% | 35% | 0.66 |
| Example 11 | SD/DB-6D | 20% | 34% | 0.61 |
| Example 12 | SD/DB-5C | 9% | 21% | 0.52 |
| Example 13 | SD/DB-6C | 15% | 22% | 0.60 |
| Example 14 | SD/DB-7D | 10% | 24% | 0.65 |
| Example 15 | DB-9C | 40% | 100% | 0.74 |

*SD/DB = Spray Dried and Dry Blended Powder; DB = Dry Blended Powder

The nutritional powders of Examples 4-15 had vibrated bulk densities of from about 0.52 g/cc to about 0.74 g/cc. The average vibrated bulk density for Examples 4-15 was about 0.61 g/cc.

The mean particle size and particle size distribution of the nutritional powders of Examples 4-15 was measured using laser diffraction, as previously described. The particle size distribution reports the range of particles sizes from the 10th percentile to the 90th percentile. The results are given in Table 8.

TABLE 8

| | | Mean | Particle Size | |
|---|---|---|---|---|
| | | Particle | Distribution (μm) | |
| | | Size | 10^{th} | |
| Example | Sample Code* | (μm) | percentile** | 90^{th} percentile*** |
| Example 4 | SD/DB-1B | 99 | 18 | 195 |
| Example 5 | SD/DB-2B | 113 | 26 | 221 |
| Example 6 | SD/DB-5A | 147 | 38 | 288 |
| Example 7 | SD/DB-4C | 101 | 22 | 203 |
| Example 8 | SD/DB-7C | 117 | 22 | 240 |
| Example 9 | SD/DB-5D | 104 | 13 | 221 |
| Example 10 | SD/DB-8C | 133 | 29 | 247 |
| Example 11 | SD/DB-6D | 123 | 37 | 236 |
| Example 12 | SD/DB-5C | 137 | 29 | 263 |
| Example 13 | SD/DB-6C | 146 | 17 | 257 |
| Example 14 | SD/DB-7D | 105 | 21 | 208 |
| Example 15 | DB-9C | 148 | 19 | 308 |

*SD/DB = Spray Dried and Dry Blended Powder; DB = Dry Blended Powder
**10% of the particles of the nutritional powder were larger than the listed particle size.
***90% of particles of the nutritional powder were smaller than the listed particle size.

The nutritional powders of Examples 4-15 had a mean particle size ranging from about 99 μm to about 148 μm. The mean particle size for Examples 4-15 was about 123 μm.

The exemplary nutritional powders of Examples 4-15 were also tested to determine the wettability in accordance with the method previously described. For example, the wettability of the nutritional powder was measured by adding a level tablespoon of the nutritional powder to the surface of 100 mL of water in a 250 mL glass beaker, and recording the time it took for the nutritional powder to fall below the surface of the water. The results of the wettability testing are shown in Table 9.

TABLE 9

| Example | Sample Code* | Wettability (seconds) |
|---|---|---|
| Example 4 | SD/DB-1B | >120 |
| Example 5 | SD/DB-2B | 92 |
| Example 6 | SD/DB-5A | >120 |
| Example 7 | SD/DB-4C | >120 |
| Example 8 | SD/DB-7C | >120 |
| Example 9 | SD/DB-5D | >120 |
| Example 10 | SD/DB-8C | >120 |
| Example 11 | SD/DB-6D | >120 |
| Example 12 | SD/DB-5C | >120 |
| Example 13 | SD/DB-6C | 2 |
| Example 14 | SD/DB-7D | >120 |
| Example 15 | DB-9C | >120 |

*SD/DB = Spray Dried and Dry Blended Powder; DB = Dry Blended Powder

As seen in Table 9, the nutritional powders of Examples 4-15 had a wettability ranging from about 2 seconds to over 120 seconds (the test stopped timing at 120 seconds). The average wettability for Examples 4-15 was at least about 108 seconds based on the recorded times.

The reconstitution time and reconstitution yield of the nutritional powders of Examples 4-5, 8-9, 11, and 15 were measured according to the Nutritional Powder Reconstitution Test method previously described. The results are given in Table 10.

TABLE 10

| | Sample | Reconstitution | Reconstitution |
|---|---|---|---|
| Example | Code | Time (sec) | Yield (%) |
| Example 4 | SD/DB-1B | 35 | 98.9 |
| Example 5 | SD/DB-2B | 30 | 96.0 |
| Example 8 | SD/DB-7C | 25 | 86.3 |
| Example 9 | SD/DB-5D | 25 | 95.8 |
| Example 11 | SD/DB-6D | 25 | 95.3 |
| Example 15 | DB-9C | 40 | 98.5 |

* SD/DB = Spray Dried and Dry Blended Powder; DB = Dry Blended Powder

As seen in Table 10, the exemplary nutritional powders of Examples 4-5, 8-9, 11, and 15 had reconstitution times ranging from about 25 seconds to about 40 seconds, with an average reconstitution time of about 30 seconds. The reconstitution yield of the tested nutritional powders ranged from about 86.3% to about 98.9%, with an average reconstitution yield of about 95.1%.

The rate of reconstitution of the nutritional powders of Examples 4-5, 8-9, 11, and 15 was measured as previously described. To determine the rate of reconstitution, aliquots of the reconstituted liquid were collected in 5-second intervals. The results of the rate of reconstitution testing are shown in Table 11.

TABLE 11

| | Sample | Reconstitution Rate (mg/g-sec) | | | | | | | |
|---|---|---|---|---|---|---|---|---|---|
| Example | Code | 0-5 sec | 5-10 sec | 10-15 sec | 15-20 sec | 20-25 sec | 25-30 sec | 30-35 sec | 35-40 sec |
| Example 4 | SD/DB-1B | 19.4 | 5.0 | 2.3 | 1.3 | 0.9 | 0.9 | 0.3 | — |
| Example 5 | SD/DB-2B | 13.7 | 5.5 | 3.2 | 5.1 | 3.3 | 0.7 | — | — |
| Example 8 | SD/DB-7C | 13.6 | 9.1 | 5.7 | 7.7 | 0.3 | — | — | — |
| Example 9 | SD/DB-5D | 16.2 | 13.7 | 1.8 | 6.4 | 0.3 | — | — | — |
| Example 11 | SD/DB-6D | 21.2 | 10.7 | 1.5 | 8.0 | 1.5 | — | — | — |
| Example 15 | DB-9C | 19.3 | 5.5 | 4.4 | 0.6 | 1.7 | 1.7 | 0.9 | 0.1 |

* SD/DB = Spray Dried and Dry Blended Powder; DB = Dry Blended Powder

The exemplary nutritional powders of Examples 4-5, 8-9, 11, and 15 had rates of reconstitution in the first 5 seconds ranging from about 13.6 mg/g-sec to about 21.2 mg/g-sec, with an average rate of reconstitution of about 17.2 mg/g-sec. The rate of reconstitution from 5 to 10 seconds for the exemplary nutritional powders of Examples 4-5, 8-9, 11, and 15 ranged from about 5.0 mg/g-sec to about 13.7 mg/g-sec, with an average rate of reconstitution of about 8.2 mg/g-sec. For the 10 to 15 seconds interval, the rate of reconstitution for the nutritional powders of Examples 4-5, 8-9, 11, and 15 ranged from about 1.5 mg/g-s to about 5.7 mg/g-sec, with an average rate of reconstitution of about 3.1 mg/g-sec. The rate of reconstitution from 15 to 20 seconds for the nutritional powders of Examples 4-5, 8-9, 11, and 15 ranged from about 0.6 mg/g-s to about 8.0 mg/g-sec, with an average rate of reconstitution of about 4.9 mg/g-sec. After 20 seconds, the rate of reconstitution for the nutritional powders of Examples 4-5, 8-9, 11, and 15 was typically less than about 3.3 mg/g-sec.

The dispersibility of the nutritional powders of Examples 4-5, 8-9, 11, and 15 were also tested in accordance with the method previously described. The results of the dispersibility testing are shown in Table 12.

TABLE 12

| | Sample | | # Particles | # Particles |
|---|---|---|---|---|
| Example | Code* | # Particles ≦1 mm | 2-4 mm | ≧5 mm |
| Example 4 | SD/DB-1B | 85 | 7 | 2 |
| Example 5 | SD/DB-2B | 54 | 8 | 0 |
| Example 8 | SD/DB-7C | 57 | 16 | 2 |
| Example 9 | SD/DB-5D | 27 | 3 | 0 |
| Example 11 | SD/DB-6D | 104 | 81 | 21 |
| Example 15 | DB-9C | 517 | 42 | 8 |

*SD/DB = Spray Dried and Dry Blended Powder; DB = Dry Blended Powder

As seen in Table 12, the nutritional powders of Examples 4-5, 8-9, 11, and 15 had a total number of particles less than or equal to 1 mm within a range of about 27 particles to about 517 particles, with an average number of particles less than or equal to 1 mm of about 141. The nutritional powders of Examples 4-5, 8-9, 11, and 15 had a total number of particles that were from 2 mm to 4 mm within a range of about 3 particles to about 81 particles, with an average number of particles from 2 mm to 4 mm of about 26. The nutritional powders of Examples 4-5, 8-9, 11, and 15 had a total number of particles that were greater than or equal to 5 mm within a range of about 0 particles to about 21 particles, with an average number of particles that were greater than or equal to 5 mm of about 6. Generally, a smaller number of undissolved particles correlates to a good dispersibility.

Comparison of Spray Dried Powder and Spray Dried/Dry Blended Powder:

A study was carried out to compare the physical and reconstitution characteristics of spray dried nutritional powders to exemplary nutritional powders according to the present disclosure, which contain a spray dried base powder and dry blended carbohydrates (hereinafter “dry blended powders”). The spray dried powders were very similar in composition to the dry blended powders. The various characteristics were measured in accordance with the methods previously discussed herein. A listing of ranges and average values for various characteristics of the spray dried powders and the dry blended powders is provided in Table 13.

TABLE 13

| | Spray Dried | Dry Blended |
|---|---|---|
| Characteristic | Powders | Powders |
| Vibrated Bulk Density (g/cc) | 0.56 to 0.63 | 0.59 to 0.63 |
| | (average 0.59) | (average 0.61) |
| Mean Particle Size (μm) | 113 to 191 | 98.7 to 113 |
| | (average 148) | (average 106) |
| Wettability (seconds) | 4.33 to 84.3 | 91.7 to >120 |
| | (average 35.4) | (average at least 106) |
| Reconstitution Time (seconds) | 25 to 40 | 30 to 35 |
| | (average 34) | (average 33) |
| Rate of Reconstitution | | |
| (mg/g-sec) (average) | | |
| 1) Beginning of Run | 17.4 | 16.6 |
| 2) After 15 seconds | 1.9 | 3.2 |
| 3) After 30 seconds | 0.7 | 0.3 |
| 4) End of Run | 0.4 | 0.7 |
| Reconstitution Yield (%) | 91.5 to 98.8 | 96 to 98.9 |
| | (average 94.1) | (average 97.4) |
| Dispersibility (average) | | |
| 1) # particles ≦1 mm | 55 | 70 |
| 2) # particles 2-4 mm | 7 | 7.5 |
| 3) # particles ≧5 mm | 1 | 1 |

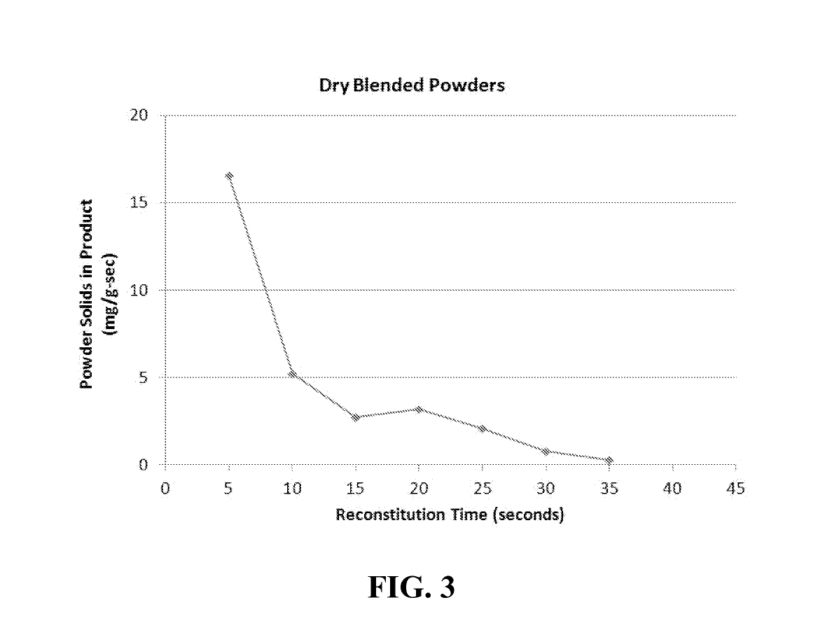

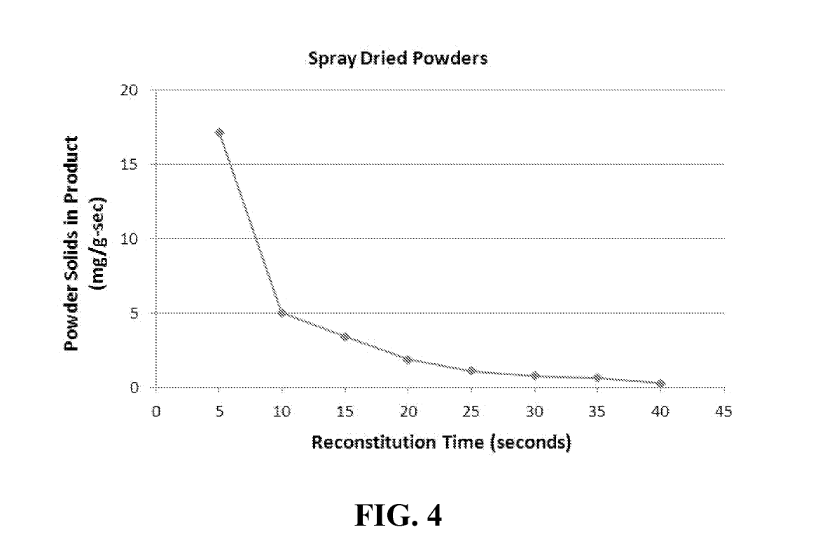

As can be appreciated from the data provided in Table 13, the dry blended powders had a higher average vibrated bulk density, a smaller average mean particle size, a longer average wettability time, a shorter average reconstitution time, a higher average reconstitution yield, and more small undissolved particles as compared to the spray dried powders. In addition, the rate of reconstitution for the dry blended powders was very similar to the rate of reconstitution for the spray dried powders. The rate of reconstitution of the dry blended powders is shown in FIG. 3, and the rate of reconstitution of the spray dried powders is shown in FIG. 4.

Based on several characteristics of the dry blended powders, it was quite unexpected to find that the dry blended powders exhibited reconstitution characteristics similar to that of the spray dried powders. For example, since the dry blended powders had a higher average vibrated bulk density and a smaller average mean particle size, it would be expected that the dry blended powder would have a longer reconstitution time and/or a lower reconstitution yield compared to the spray dried powders since the dry blended powder is packed tighter, making it more difficult for water to penetrate during reconstitution. In addition, the longer average wettability time associated with the dry blended powders would be expected to result in a longer reconstitution time and/or a lower reconstitution yield compared to the spray dried powders due to the fact that the longer wettability time indicates that more time is needed to fully reconstitute. Yet, the dry blended powders exhibited a reconstitution time and a reconstitution yield similar to that of the spray dried powders.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

All percentages, parts, and ratios as used herein are by weight of the total composition, unless otherwise specified. All such weights as they pertain to listed ingredients are based on the active level and, therefore, do not include solvents or by-products that may be included in commercially available materials, unless otherwise specified.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein may be performed in any order, unless otherwise specified or clearly implied to the contrary by the context in which the referenced combination is made.

The nutritional powder pods and corresponding manufacturing methods of the present disclosure can comprise, consist of, or consist essentially of the essential elements of the disclosure as described herein, as well as any additional or optional element described herein or which is otherwise useful in nutritional powder applications.

The nutritional compositions, infant formulas, and corresponding manufacturing methods of the present disclosure can comprise, consist of, or consist essentially of the essential elements and limitations of the disclosure as described herein, as well as any additional or optional ingredients, components, or limitations described herein or otherwise useful in nutritional powdered formula applications.

The nutritional powders of the present disclosure may be substantially free of any optional or selected essential ingredient or feature described herein, provided that the remaining nutritional powder still contains all of the required ingredients or features as described herein. In this context, and unless otherwise specified, the term “substantially free” means that the selected composition contains less than a functional amount of the optional ingredient, typically less than 0.1% by weight, and also including zero percent by weight, of such optional or selected essential ingredient.

The compositions of the present disclosure may be packaged and sealed in single or multi-use containers, and then stored under ambient conditions or under refrigeration for up to 36 months or longer, more typically from about 6 months to about 24 months. For multi-use containers, these packages can be opened and then closed for repeated use by the ultimate user. Non-limiting examples of ways in which the present nutritional powder pods may be utilized include their use in a beverage production machine to produce the following liquid products: a hot beverage (e.g., coffee, tea, or cocoa); a tepid or cool beverage (e.g., an infant formula, a malted beverage, a fruit or juice beverage, a carbonated beverage, a soft drink, or a milk based beverage); a performance beverage (e.g., a performance ready-to-drink beverage); or a functional beverage (e.g., a slimming beverage, a fat burning beverage, a product for improving mental performance or preventing mental decline, or a skin improving product).

To the extent that the terms “include,” “includes,” or “including” are used in the specification or the claims, they are intended to be inclusive in a manner similar to the term “comprising” as that term is interpreted when employed as a transitional word in a claim. Furthermore, to the extent that the term “or” is employed (e.g., A or B), it is intended to mean “A or B or both A and B.” When the applicants intend to indicate “only A or B but not both,” then the term “only A or B but not both” will be employed. Thus, use of the term “or” herein is the inclusive, and not the exclusive use. In the present disclosure, the words “a” or “an” are to be taken to include both the singular and the plural. Conversely, any reference to plural items shall, where appropriate, include the singular.

In certain embodiments, it may be possible to utilize the various inventive concepts in combination with one another (e.g., one or more of the various embodiments may be utilized in combination with each other). Additionally, any particular element recited as relating to a particularly disclosed embodiment should be interpreted as available for use with all disclosed embodiments, unless incorporation of the particular element would be contradictory to the express terms of the embodiment. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

1. A nutritional powder pod for use in a beverage production machine comprising:
a pod containing a nutritional powder;
wherein the nutritional powder comprises a carbohydrate and at least one of a protein and a fat; and
wherein at least about 5 wt % of the carbohydrate in the nutritional powder is provided by a dry blended carbohydrate.

2. The nutritional powder pod according to claim 1, wherein the nutritional powder has a rate of reconstitution of from about 0.1 mg/g-sec to about 25 mg/g-sec.

3. The nutritional powder pod according to claim 1, wherein from about 10 wt % to about 100 wt % of the carbohydrate in the nutritional powder is provided by a dry blended carbohydrate.

4. (canceled)

5. (canceled)

6. The nutritional powder pod according to claim 1, wherein the pod contains from about 2 grams to about 150 grams of the nutritional powder.

7. The nutritional powder pod according to claim 1, wherein the dry blended carbohydrate comprises lactose.

8. The nutritional powder pod according to claim 1, wherein the dry blended carbohydrate comprises sucrose.

9. The nutritional powder pod according to claim 1, wherein the dry blended carbohydrate comprises lactose and sucrose.

10. The nutritional powder pod according to claim 9, wherein the dry blended lactose and dry blended sucrose are present in relative weight amounts ranging from about 10:90 to about 90:10.

11. The nutritional powder pod according to claim 1, wherein the dry blended carbohydrate comprises sucrose and maltodextrin.

12. (canceled)

13. (canceled)

14. The nutritional powder pod according to claim 1, wherein the nutritional powder comprises a total amount of carbohydrate of from about 40% to about 80% by weight of the nutritional powder.

15. A method of manufacturing a nutritional powder pod for use in a beverage production machine, the method comprising:
providing a base nutritional powder;
dry blending a carbohydrate into the base nutritional powder to form a final nutritional powder;
enclosing the final nutritional powder into a pod, thereby forming a nutritional powder pod;
wherein at least about 5 wt % of the carbohydrate is dry blended into the final nutritional powder.

16. The method according to claim 15, wherein the nutritional powder has a rate of reconstitution of from about 0.1 mg/g-sec to about 25 mg/g-sec.

17. The method according to claim 15, wherein from about 10 wt % to about 100 wt % of the carbohydrate is dry blended into the final nutritional powder.

18. (canceled)

19. The method according to claim 15, wherein the base nutritional powder is a spray dried powder.

20. The method according to claim 15, wherein the base nutritional powder is an extruded powder.

21. The method according to claim 15, wherein the base nutritional powder is agglomerated.

22. The method according to claim 15, wherein the step of enclosing the final nutritional powder into a pod comprises:
dispensing a predetermined amount of the final nutritional powder into the pod; and
closing the pod containing the final nutritional powder.

23. The method according to claim 22, wherein the step of closing the pod comprises hermetically sealing the pod.

24. A package containing a plurality of nutritional powder pods according to claim 1.

25. (canceled)

26. A process for preparing a liquid product comprising:
using a nutritional powder pod according to claim 1 with a beverage production machine to mix a liquid with the nutritional powder in the nutritional powder pod such that the nutritional powder contained therein is reconstituted, thereby producing a liquid product.

27.-33. (canceled)
